(19) United States
(12) Patent Application Publication
(10) Pub. No.: US 2026/0103842 A1
(43) Pub. Date: Apr. 16, 2026

(54) EMULSIONS FOR BIODEGRADABLE AND RECYCLABLE PAPER COATING

(71) Applicant: BOARD OF TRUSTEES OF MICHIGAN STATE UNIVERSITY, East Lansing, MI (US)

(72) Inventors: Muhammad Rabnawaz, Okemos, MI (US); Ajmir Khan, East Lansing, MI (US); Sarla Yadav, East Lansing, MI (US)

(21) Appl. No.: 19/355,263

(22) Filed: Oct. 10, 2025

Related U.S. Application Data
(60) Provisional application No. 63/706,161, filed on Oct. 11, 2024.

(51) Int. Cl. D21H 19/58; C08F 118/08; C08F 118/10; C09D 5/02; C09D 131/04; D21H 19/82; D21H 19/84

(52) U.S. Cl. CPC D21H 19/58; C08F 118/08; C08F 118/10; C09D 5/022; C09D 5/027; C09D 131/04; D21H 19/828; D21H 19/84; C08F 2800/10; C08F 2800/20

(57) ABSTRACT

The disclosure relates to ethylenic polymers containing repeat units having pendant groups that can be linked to an ethylenic backbone via ester groups, such as those resulting from vinyl alkanoate monomers and alkyl (meth)acrylate monomers. The ethylenic polymer generally includes first repeat units in combination with one or more of second repeat units, third repeat units, and fourth repeat units. The first repeat units can include vinyl alkanoate monomer residues, the second repeat units can include alkyl (meth)acrylate residues, the third repeat units can include pendant carboxylic groups, and the fourth repeat units can include pendant aromatic groups. The combined structure of the ethylenic polymer is suitable for the formation of high-solids aqueous emulsions or dispersions, which can be used to apply a waterborne coating to a substrate such as paper. The ethylenic polymer and coatings therefrom can provide good water resistance, good oil resistance, recyclability, repulpability, and/or biodegradability.

### CROSS REFERENCE TO RELATED APPLICATION

Priority is claimed to U.S. Provisional Application No. 63/706,161 (filed Oct. 11, 2024), which is incorporated herein by reference in its entirety.

### STATEMENT OF GOVERNMENT INTEREST

None.

### BACKGROUND OF THE DISCLOSURE

### Field of the Disclosure

The disclosure relates to ethylenic polymer emulsions for paper coatings. The ethylenic polymer can be a copolymer including vinyl alkanoate monomers and alkyl (meth)acrylate monomers. The polymer components can be blended with other materials.

The paper coatings have good water repellency. The obtained coated paper can be recyclable, repulpable, and/or biodegradable. The polymer emulsions and coated papers provide sustainable alternatives for existing coated paper products such as corrugated boxes, cups, plates, and adhesives, etc.

### Background

Plastics, particularly laminated materials and per- and polyfluoroalkyl substances (PFAS) used in packaging, have imposed a significant burden on the environment. In response, some single-use plastic items have been banned. However, this ban has limited effectiveness as there is no reasonable alternative available to manufacturers. Moreover, according to the U.S. Centers for Disease Control and Prevention (CDC), over 95% of the U.S. population has harmful fluorochemicals (PFAS) in their bodies.

Paper products fulfill indispensable roles in everyday lives because of their affordability, biodegradability, and renewability. However, paper is porous and polar in nature, and thus it has poor water and grease resistance. The water resistance of paper is measured as the Cobb60 value, representing the amount of grams of water per square meter that a paper absorbs in 60 seconds when it is brought into contact with water. Meanwhile, grease resistance is represented by a kit rating value, where a value of 12/12 denotes the maximum grease resistance, and 0/12 corresponds to no grease resistance. Several approaches are employed to improve water resistance, such as the use of sizing agents, chemical modification, physicochemical modification, and layer-by-layer assembly.

The lamination and coating of paper substrates is a popular strategy to fabricate water- and grease-resistant paper. For example, low-density polyethylene (LDPE) is the most common plastic used as a liner for paper substrates to enhance their liquid repellency. Waxed paper is also used for low temperature packaging applications. However, the separation of coatings and laminates from paper fibers or pulp during the repulping process presents a significant challenge and these materials are not biodegradable. Acrylic coatings are also used for paper coating to impart some degree of water and oil resistance to the paper. However, an acrylic-coated paper can be recycled only, but is not biodegradable. Biobased polymers such as polylactic acid (PLA) have also been used to laminate paper. However, PLA separation from pulp is a challenging task. Wax coatings are sometimes combined with biodegradable coatings to coat paper, but the coated substrates are adequate for low-temperature applications only. Parchment paper is also water- and oil-proof (for a short period of time). However, parchment paper is not suitable due to the extensive use of chemicals (e.g., ZnCl2, sulfuric acid) and energy during its production and due to its poor recyclability. PFAS are also used to fabricate water- and grease-resistant paper. However, there have been calls for alternatives to these materials due to environmental concerns.

U.S. Publication No. 2021/0253901 is directed to biodegradable omniphobic coatings. The omniphobic coating includes a reaction product between an amino-functional polymer and an amino-reactive functionalized omniphobic polymer having a glass transition temperature (T_{g}) of 60° C. or less. A corresponding omniphobic coated article can include the omniphobic coating on a porous substrate such as a cellulosic or paper substrate, for example to provide a water- and oil/fat/grease-resistant coating for a paper-based product.

U.S. Publication No. 2021/0246333 is directed to biodegradable omniphobic and high-barrier coatings. The omniphobic coating includes an oleophobic and hydrophilic first layer, and a hydrophobic and optionally oleophilic second layer adjacent to the first layer. A corresponding omniphobic coated article can include the omniphobic coating on a substrate such as a porous cellulosic or paper substrate, for example to provide a water- and oil/fat/grease-resistant coating for a paper-based product.

International Publication No. WO 2024/215970 is directed to synthetic wax compositions including at least one long-chain hydrocarbon residue having 12 to 40 carbon atoms, and at least one oligomeric residue containing 4 to 20 or 4 to 50 glycolic acid units and/or lactic acid units. The synthetic wax can be used as a coating on substrates such as paper substrates, to impart water and/or oil resistance to the substrate.

International Application No. PCT/US25/26354 is directed to ionizable polyesters containing repeat units having polymeric or oligomeric polyester segments and linkers between the polyester segments having ionizable groups. The ionizable polyesters can be used as water- and oil-resistant barrier coatings on cellulosic substrates such as paper.

### SUMMARY

In an aspect, the disclosure relates to an ethylenic polymer comprising: first repeat units according to Formula (1) and at least one of second repeat units according to Formula (2), third repeat units according to Formula (3), and fourth repeat units according to Formula (4):

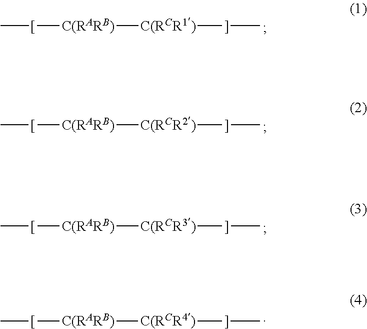

In Formulas (1)-(4): R^{A}, R^{B}, and R^{C} are independently selected from the group consisting of H and a hydrocarbon group containing 1 to 6 carbon atoms (e.g., can be the same or different selections each of Formulas (1)-(4); R^{A}, R^{B}, and R^{C} are H in a vinyl or an acrylate residue; R^{A} and R^{B} are H, and R^{C} is CH₃ in a methacrylate residue); R^{1′} is —OC(═O)—R¹; R¹ is a hydrocarbon group containing 1 to 40 carbon atoms; R^{2′} is —C(═O)O—R²; R² is a hydrocarbon group containing 1 to 40 carbon atoms; R^{3′} is selected from the group consisting of —C(═O)O—R³ and —C(═O)NH₂; R³ is H or a hydrocarbon group containing 1 to 40 carbon atoms and having at least one carboxylic group (and optionally other groups such as esters, ethers, etc.); and R⁴ is a hydrocarbon group containing 6 to 40 carbon atoms and having at least one aromatic group. In embodiments, the ethylenic polymer can include any combination of the Formula (2), (3), and (4) repeat units along with the Formula (1) repeat units (e.g., Formula (2), (3), or (4) only; Formulas (2)/(3), (2)/(4), or (3)/(4) only; Formula (2), (3), and (4)). In a particular embodiment, the ethylenic polymer includes the Formula (1) and Formula (3) repeat units, optionally in combination with one or both of the Formula (2) and Formula (4) repeat units.

Various refinements of the ethylenic polymers are possible.

In a refinement, the first repeat units are present in an amount in a range of 50 wt. % to 95 wt. % relative to the ethylenic polymer.

In a refinement, the second repeat units are present in the ethylenic polymer in an amount in a range of 5 wt. % to 50 wt. % relative to the ethylenic polymer; and R² is an alkyl hydrocarbon group containing 1 to 18 carbon atoms. In an alternative refinement, the second repeat units are absent from the ethylenic polymer.

In a refinement, the third repeat units are present in the ethylenic polymer in an amount in a range of 0.1 wt. % to 5 wt. % or 0.1 wt. % to 10 wt. % relative to the ethylenic polymer; and R³ is H or a hydrocarbon group containing 1 to 6 carbon atoms and having at least one carboxylic group.

In a refinement, the fourth repeat units are present in the ethylenic polymer in an amount in a range of 1 wt. % to 40 wt. % relative to the ethylenic polymer; and R⁴ is an aromatic hydrocarbon group containing 6 to 12 carbon atoms. In an alternative refinement, the fourth repeat units are absent from the ethylenic polymer.

In a refinement, the first repeat units comprise repeat units according to Formula (1A) and repeat units according to Formula (1B):

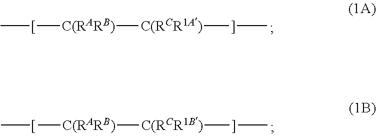

wherein: R^{1A′} is —OC(═O)—R^{1A}; R^{1A} is a hydrocarbon group containing 9 to 40 carbon atoms (e.g., a relatively heavier vinyl alkanoate such as vinyl laurate or vinyl stearate); R^{1B′} is —OC(═O)—R^{1B}; and R^{1A} is a hydrocarbon group containing 1 to 8 carbon atoms (e.g., a relatively heavier vinyl alkanoate such as vinyl acetate or vinyl propanoate).

In a further refinement, a weight ratio of the repeat units according to Formula (1A) relative to the repeat units according to Formula (1B) is in a range of 0.1 to 2.

In a further refinement, the first repeat units are present in an amount in a range of 70 wt. % to 90 wt. % or in a range of 70 mol. % to 90 mol. % relative to the ethylenic polymer; the repeat units according to Formula (1A) are present in an amount in a range of 10 wt. % to 30 wt. % or in a range of 5 mol. % to 20 mol. % relative to the ethylenic polymer; the repeat units according to Formula (1B) are present in an amount in a range of 50 wt. % to 70 wt. % or in a range of 60 mol. % to 80 mol. % relative to the ethylenic polymer; a weight ratio of the repeat units according to Formula (1A) relative to the repeat units according to Formula (1B) is in a range of 0.2 to 0.5; a molar ratio of the repeat units according to Formula (1A) relative to the repeat units according to Formula (1B) is in a range of 0.05 to 0.2; the second repeat units are present in the ethylenic polymer in an amount in a range of 5 wt. % to 20 wt. % or 3 mol. % to 15 mol. % relative to the ethylenic polymer; the third repeat units are present in the ethylenic polymer in an amount in a range of 0.2 wt. % to 4 wt. % or 0.5 mol. % to 8 mol. % relative to the ethylenic polymer; and the fourth repeat units are present in the ethylenic polymer in an amount in a range of 5 wt. % to 30 wt. % or 5 mol. % to 30 mol. % relative to the ethylenic polymer.

In a further refinement, R^{A}, R^{B}, and R^{C} are H in the repeat units of Formula (1A), Formula (1B), Formula (3), and Formula (4) (e.g., vinyl or acrylic units); R^{A} and R^{B} are H, and R^{C} is CH₃ in the repeat units of Formula (2) (e.g., methacrylic units); R^{1A} is an alkyl hydrocarbon group containing 10 to 20 carbon atoms (e.g., 11 carbon atoms for vinyl laurate); R^{1B} is an alkyl hydrocarbon group containing 1 to 4 carbon atoms (e.g., 1 carbon atoms for vinyl acetate); R² is an alkyl hydrocarbon group containing 1 to 6 carbon atoms (e.g., 4 carbon atoms for butyl methacrylate); R³ is H or a hydrocarbon group containing 1 to 6 carbon atoms and having at least one carboxylic group (e.g., H for acrylic acid or 3 carbon atoms for 2-carboxyethyl acrylate); and R⁴ is an aromatic hydrocarbon group containing 6 to 12 carbon atoms (e.g., 6 carbon atoms for styrene).

In a refinement, the ethylenic polymer has a molecular weight in a range of 1,000 g/mol to 1,000,000 g/mol; and the ethylenic polymer is a statistical, random, blocky copolymer (e.g., also generally linear or unbranched and not crosslinked).

In another aspect, the disclosure relates to a method for forming an ethylenic polymer according to the disclosure, the method comprising: polymerizing in an aqueous medium first ethylenic monomers corresponding to Formula (1) and at least one of second ethylenic monomers corresponding to Formula (2), third ethylenic monomers corresponding to Formula (3), and fourth ethylenic monomers corresponding to Formula (4), thereby forming the ethylenic polymer (e.g., aqueous emulsion polymerization of the ethylenic monomers with 0.05-5 wt. % of free radical initiators (e.g., thermal initiator, redox initiator, radiation-induced initiator) to form an emulsion of the ethylenic polymer). Optionally, a chain transfer agent (CTA) can be used to regulate polymer molecular weight during polymerization, in particular by terminating a growing polymer chain and initiating a new polymer chain, thus controlling chain length and dispersity. In embodiments, the aqueous polymerization medium can include any combination of the second, third, and fourth ethylenic monomers along with the first ethylenic monomers. In a particular embodiment, the aqueous polymerization medium includes the first and third ethylenic monomers, optionally in combination with one or both of the second and fourth ethylenic monomers.

In another aspect, the disclosure relates to an ethylenic polymer emulsion (or dispersion) comprising: an aqueous medium; and an ethylenic polymer according to the disclosure dispersed in the aqueous medium.

Various refinements of the ethylenic polymer emulsion or dispersion are possible.

In a refinement, water is present in the aqueous medium in an amount of 50 wt. % to 99 wt. % relative to the emulsion (or 60 wt. % to 90 wt. %); and the ethylenic polymer is present in the aqueous medium in an amount of 1 wt. % to 50 wt. % (or 10 wt. % to 40 wt. %) relative to the emulsion.

In a refinement, the ethylenic polymer emulsion or dispersion further comprises an emulsifier in an amount of (i) 0.1 wt. % to 10 wt. % relative to the emulsion or (ii) 1 wt. % to 20 wt. % relative to the ethylenic polymer (e.g., any suitable emulsifier forming an oil-in-water emulsion, such as sodium stearate or sodium dodecyl sulfate).

In another aspect, the disclosure relates to a coated article comprising: a substrate; and a coating on the substrate, the coating comprising the ethylenic polymer according to the disclosure.

Various refinements of the coated article are possible.

In a refinement, the substrate is a cellulosic substrate.

In a refinement, the coating comprises one or more additives blended with the ethylenic polymer.

In a refinement, the additives are present in an amount of 0.1 wt. % to 90 wt. % (or 0.5 wt. % to 50 wt. %) relative to the ethylenic polymer (or relative to the coating); and the additives are selected from the group consisting of inorganic fillers, organic additives, polymeric fillers, nanoparticles, natural waxes, ionizable synthetic or natural polymers, non-ionizable synthetic or natural hydrophilic polymers, and combinations thereof. In embodiments, the additives can be present in amounts of at least and/or up to 0.1, 0.2, 0.5, 1, 2, 5, 10, 20, 30, 40, 50, 60, 70, 80, 90 wt. % relative to the ethylenic polymer or relative to the coating.

In a further refinement, the inorganic filler is present and is selected from the group consisting of modified or unmodified titanium dioxide, modified or unmodified silica, modified or unmodified clay, calcium carbonate, aluminum oxide, zinc oxide, talc, mica, barium sulfate, iron oxides, and combinations thereof. The fillers can be used as their hydrolyzed forms or their salt form (such as alum). The fillers can have various roles, such as thickeners, surface energy modifiers, sealing properties, etc.

In a further refinement, the organic additive is present and is selected from the group consisting of acrylics, polyurethane, epoxy, alkyds, water dispersible ionizable polyesters, water dispersible ionizable synthetic waxes, natural waxes, petroleum waxes, polyhydrocarbons, silicone, vinylic, vinylic-acrylics, polyamide, modified or unmodified carbohydrates (starch, cellulose, chitosan, alginates), cellulose nanofiber and cellulose nanocrystals, polyvinyl alcohol (e.g., with different degree of hydrolysis), polyethylene vinyl alcohols acrylic acid, polyethylene vinyl alcohol, proteins, lignin (such as kraft lignin predispered in water using a base), polyethers, polyether-polyesters, amine/imine containing polymers (e.g., polyethyleneimine), and combinations thereof. The various organic additives can be anionic, cationic, or neutral, such as cationic acrylics, anionic acrylics, cationic starches, neutral/cationic/anionic starches, etc.

In a refinement, the coated article has a kit rating in a range of 4 to 12 (or 1 to 12); the coated article has a cobb600 rating of 50 g/m² or less (or 80 g/m² or less); the coated article has a moisture permeability value between 0.0001-40 g·mm/m²·24 h (or 0.0001-100 g·mm/m²·24 h) at 37° C. and 90% RH; and the coated article has an oxygen permeability value between 0.0001-200 cc·mm/m²·24 h at 37° C. and 90% RH.

In a refinement, the coated article is one or more of biodegradable, repulpable, and recyclable.

In a refinement, the coated article further comprises a barrier layer (e.g., between the substrate and the coating).

In another aspect, the disclosure relates to a coated cellulosic substrate, comprising: a cellulosic material (e.g., paper pulp or fiber); and the ethylenic polymer according to the disclosure distributed throughout the cellulosic material as an internal sizing. In a refinement, the ethylenic polymer can be present in an amount of up to 20 wt. % or 0.5-5 wt. % relative to the cellulosic substrate as a whole. In another aspect, the ethylenic polymer (e.g., with or without fillers or additives) can be used as surface sizing for molded fiber 2D and 3D objects, such as spraying on the internally sized/unsized fiber to enhance water and oil resistance. Surface sizing is applied to the formed web at the size press stage.

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a schematic of a coated article including an ethylenic polymer coating according to an embodiment of the disclosure.

FIG. 2 is a schematic of a coated article including an ethylenic polymer coating according to another embodiment of the disclosure.

FIG. 3 is a schematic of a coated article including an ethylenic polymer coating according to another embodiment of the disclosure.

FIG. 4 is a schematic of a coated article including an ethylenic polymer coating according to another embodiment of the disclosure.

FIG. 5 is a scheme illustrating synthesis and structure of an ethylenic polymer according to an embodiment of the disclosure.

FIG. 6 is a scheme illustrating synthesis and structure of an ethylenic polymer according to another embodiment of the disclosure.

### DETAILED DESCRIPTION

Approximately 40% of all plastics produced today are used in the packaging sector. The most significant sustainable packaging hurdle is access to new materials that are universally compostable, are repulpable and/or recyclable, are available at commodity prices, and have performance matching or exceeding those of the existing polymers. The disclosure relates to ethylenic (co)polymers and related waterborne emulsions for paper coatings. The polymer components can be blended with other materials. A paper coated with a waterborne emulsion of the disclosed polymers has water and oil resistance matching that of conventional plastic-coated paper. The materials developed by this approach can be biodegradable (e.g., biodegrade in the ocean, soil, and industrial compost environment), as well as on-demand degradable during repulping (washing off from paper etc.). The biodegradability aspect mitigates microplastics that are currently building up in the ocean and soil, while repulping provides a closed-loop recycling process for paper coated with the disclosed polyesters.

The disclosed ethylenic polymers meet a timely need for plastic- and perfluoroalkyl substance (PFAS)-free paper coating that offers strong barrier performance while being both recyclable as well as biodegradable. The ethylenic polymers can be formed in a ready-to-use water-based coating formulation based on vinyl alkanoate emulsions, which are particularly suitable for applications used in food packaging industry. This ethylenic polymer can be used by paper converters or packaging manufacturers that produce items such as paper cups, plates, wrappers, takeout containers, and coated corrugated boxes for fruits and vegetables. The ethylenic polymer coating emulsion can be incorporated into existing paper-coating lines, with minimal process modifications. The disclosed ethylenic polymer can be used as a replacement for traditional polyethylene (PE)-, wax-, PFAS-, polyester-, and acrylic-coated paper, as demonstrated by the attributes in Table 1.

TABLE 1
Comparison of Paper-Coating Technologies

| Technology | Pros | Cons | Uses |
|---|---|---|---|
| Polyethylene (PE) | Excellent water and oil | Nonrecyclable. PE is | Disposable single-use, |
| | resistance; | nonbiodegradable | paper-based packaging |
| | low-cost¹⁸ | | |
| Wax such as Paraffin | Excellent water and oil | Paraffin wax is | Corrugated boxes |
| | resistance; moderate cost | nonrecyclable as well as | |
| | | non-biodegradable | |
| Polyester | Good water and oil | Non-recyclable | Disposable paper plates |
| | resistance; industry/home | | and cups |
| | compostable | | |
| Acrylic | Good water and oil | Non-biodegradable | Disposable paper plates |
| | resistance; Ability to | | and cups |
| | recycle depends on | | |
| | coating nature and | | |
| | amount applied | | |
| PFAS | Good oil resistance | PFAS release into food and | Take-out containers, food |
| | | environment | wrappers |
| Ethylenic Polymer | Good water and oil | | Corrugated boxes, |
| (present disclosure) | resistance; recyclable; | | disposable paper plates |
| | disintegrates in compost | | and cups, food wrappers, |
| | conditions | | take-out containers |

Compared to the paper-coating technologies in Table 1, the disclosed ethylenic polymer can be recyclable, repulpable, and/or biodegradable. The examples below indicate that the ethylenic polymer coating can provide necessary water and oil resistance properties for food packaging applications. In addition, the ethylenic polymer-coated paper also passes the Fiber Box Association (FBA) recyclability protocol, which simulates mill-scale repulping (fiber recovery) and evaluates whether coated paper can be processed without clogging screens and forming stickies. Passing this test demonstrates that the disclosed ethylenic polymer coating is compatible with existing recycling infrastructure.

The disclosure relates to ethylenic polymers containing repeat units having pendant groups that can be linked to an ethylenic backbone via ester groups, such as those resulting from vinyl alkanoate monomers and alkyl (meth)acrylate monomers. The ethylenic polymer generally includes first repeat units in combination with one or more of second repeat units, third repeat units, and fourth repeat units. The first repeat units can include vinyl alkanoate monomer residues, for example a combination of short- and long-chain alkanoates to promotes biodegradation and to impart water resistance, respectively, in the final ethylenic polymer. The second repeat units can include alkyl (meth)acrylate residues, which can adjust the glass transition temperature (Tg) of the ethylenic polymer. The third repeat units can include pendant carboxylic groups to promote recyclability and emulsion stability. The fourth repeat units can include pendant aromatic groups. The combined structure of the ethylenic polymer is suitable for the formation of high-solids aqueous emulsions or dispersions, which can be used to apply a waterborne coating to a substrate. The ethylenic polymer and coatings therefrom can provide one or more favorable properties, including good water resistance (e.g., cobb rating), good oil resistance (e.g., kit rating), recyclability, repulpability, and/or biodegradability.

The ethylenic polymers are particularly suitable for use as water- and oil-resistant barrier coatings on cellulosic substrates such as paper, providing good barrier properties while also providing coatings and coated articles that are biodegradable, compostable, recyclable, and/or repulpable. The coated articles can be used as packaging containers (cups, plates, boxes, etc.), lids, thermoforms, pouches, and/or rigid bottles. The coated articles can have an oxygen permeability value between 0.0001-200 cc·mm/m²·24 h at 37° C. and 90% RH. The coated articles can have a moisture permeability value between 0.0001-40 g·mm/m²·24 h (or 0.0001-100 g·mm/m²·24 h) at 37° C. and 90% RH. The coated articles can have a Cobb600 value of 70 g/m² or less, and a kit rating of at least 4. The coated articles can be recyclable where paper is pulped (e.g., when the article substrate includes paper), and the recovered paper fiber can be used for making new paper without any significant stickies formation. The ethylenic polymers can be provided in the form of an aqueous emulsion of the ethylenic polymers, which is a particularly suitable form for applying a coating of the ethylenic polymers onto a substrate.

### Ethylenic Polymer and Emulsion

An ethylenic polymer according to the disclosure can include first repeat units, second repeat units, third repeat units, and/or fourth repeat units. The ethylenic polymer generally includes one, two, three, or more different types of the first repeat units in combination with one or more of the second, third, and/or fourth repeat units. The repeat units form an ethylenic backbone generally corresponding to polymerized vinyl and/or (meth)acrylic monomer units. In embodiments, the first repeat units can be represented by Formula (1), the second repeat units can be represented by Formula (2), the third repeat units can be represented by Formula (3), and/or the fourth repeat units can be represented by Formula (4):

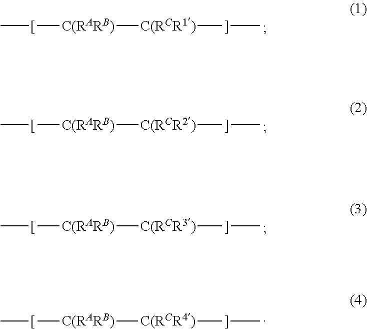

In each or Formulas (1)-(4), R^{A}, R^{B}, and R^{C} can be independently selected from H (hydrogen atom) and a hydrocarbon group containing 1 to 6 carbon atoms, for example 1, 2, 3, 4, 5, or 6 carbon atoms. Example hydrocarbon groups for R^{A}, R^{B}, and R^{C} include methyl, ethyl, propyl, etc. The hydrocarbon groups can include linear, branched, or cyclic, substituted or unsubstituted alkyl or alkenyl (e.g., having one or more C═C unsaturated bonds) groups, for example with or without N, O, and/or S heteroatoms or heteroatom-containing groups as substituents. Each repeat unit can have independent selections for R^{A}, R^{B}, and R^{C}, whether for different repeat units among different Formulas (1)-(4), of for different repeat units within the same general formula (e.g., multiple different first repeat units according to Formula (1). In embodiments, R^{A}, R^{B}, and R^{C} can be H in a vinyl or an acrylate residue of the repeat unit. In embodiments, R^{A} and R^{B} can be H, and R^{C} can be CH₃ in a methacrylate residue of the repeat unit.

In the first repeat units of Formula (1), the R^{1′} group can be represented by —OC(═O)—R¹, in which the oxygen atom (O) of the ester group (—OC(═O)—) is bonded to the carbon atom of the ethylenic backbone, and the carbonyl group (C(═O)) carbon atom is bonded to the pendant R¹ group. The R¹ group can be a hydrocarbon group containing 1 to 40, 1 to 8, or 9 to 40 carbon atoms, for example at least and/or up to 1, 2, 3, 4, 5, 6, 7, 8, 9, 10, 12, 14, 16, 18, 20, 25, 30, 35, or 40 carbon atoms and ranges therebetween. The hydrocarbon groups can include linear, branched, or cyclic, substituted or unsubstituted alkyl or alkenyl (e.g., having one or more C═C unsaturated bonds) groups, for example with or without N, O, and/or S heteroatoms or heteroatom-containing groups as substituents. In embodiments, the hydrocarbon group is an unsubstituted alkyl group. In embodiments, the first repeat units of Formula (1) can represent polymerized residues of vinyl alkanoates, for example where R^{A}, R^{B}, and R^{C} are all H atoms, and R¹ is an alkyl group. Representative vinyl alkanoates can include vinyl acetate (i.e., R¹ is a C1 alkyl group), vinyl propanoate (i.e., R¹ is a C2 alkyl group), vinyl laurate (i.e., R¹ is a C11 alkyl group), vinyl stearate (i.e., R¹ is a C17 alkyl group), etc.

In embodiments, the first repeat units can be present in an amount in a range of 50 wt. % to 95 wt. % or 70 wt. % to 90 wt. % relative to the ethylenic polymer, for example at least and/or up to 50, 55, 60, 65, 70, 75, 80, 85, 90, or 95 wt. % and ranges therebetween. Alternatively or additionally, the first repeat units can be present in an amount in a range of 50 mol. % to 95 mol. % or 70 mol. % to 90 mol. % relative to the ethylenic polymer, for example at least and/or up to 50, 55, 60, 65, 70, 75, 80, 85, 90, or 95 mol. % and ranges therebetween. The foregoing amounts and ranges can represent a combined amount of all first repeat units in the ethylenic polymer, for example when the ethylenic polymer includes multiple different types of first repeat units.

In embodiments, the first repeat units can include more than one type of repeat unit within the general structure of Formula (1), for example resulting from copolymerization of a mixture of different monomers corresponding to Formula (1). For example, the first repeat units can include repeat units according to Formula (1A) and different repeat units according to Formula (1B):

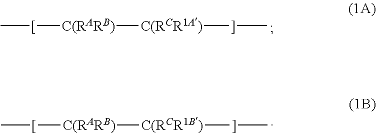

In Formula (1A), R^{1A′} can be —OC(═O)—R^{1A}, where R^{1A} can be a hydrocarbon group as described above for R¹. In Formula (1B), R^{1B′} can be —OC(═O)—R^{1B}, where R^{1B} can be a hydrocarbon group as described above for R¹. Likewise, the first repeat units can include an additional, analogous repeat unit within the general structure of Formula (1) (e.g., a Formula (1C) different from Formulas (1A) and (1B), multiple different repeat units according to Formula (1A), multiple different repeat units according to Formula (1B), etc.). In embodiments, the Formula (1A) repeat unit can be selected to include relatively longer (alkyl) side chains that impart water resistance to the ethylenic polymer, such as vinyl laurate or vinyl stearate residues, for example where R^{1A} has at least 7, 8, 9, or 10 carbon atoms, for example at least and/or up to 7, 8, 9, 10, 12, 14, 16, 18, 20, 25, 30, 35, or 40 carbon atoms and ranges therebetween. In embodiments, the Formula (1B) repeat unit can be selected to include relatively shorter (alkyl) side chains that promote biodegradation of the ethylenic polymer, such as vinyl acetate or vinyl propanoate residues, for example where R^{1B} has up to 6, 7, 8, or 9 carbon atoms, for example at least and/or up to 1, 2, 3, 4, 5, 6, 7, 8, or 9 carbon atoms and ranges therebetween. In embodiments, the R^{1A} group(s) contain more carbon atoms than the R^{1B} group(s).

In embodiments, the repeat units of Formula (1A) can be present in an amount in a range of 10 wt. % to 30 wt. % relative to the ethylenic polymer, for example at least and/or up to 10, 15, 20, 25, or 30 wt. % and ranges therebetween. Alternatively or additionally, the repeat units of Formula (1A) can be present in an amount in a range of 5 mol. % to 20 mol. % relative to the ethylenic polymer, for example at least and/or up to 5, 10, 15, or 20 mol. % and ranges therebetween. In embodiments, the repeat units of Formula (1B) can be present in an amount in a range of 50 wt. % to 70 wt. % relative to the ethylenic polymer, for example at least and/or up to 50, 55, 60, 65, or 70 wt. % and ranges therebetween. Alternatively or additionally, the repeat units of Formula (1B) can be present in an amount in a range of 60 mol. % to 80 mol. % relative to the ethylenic polymer, for example at least and/or up to 60, 65, 70, 75, or 80 mol. % and ranges therebetween. In embodiments, a weight ratio of the repeat units according to Formula (1A) relative to the repeat units according to Formula (1B) can be in a range of 0.1 to 2 or 0.2 to 0.5, for example at least and/or up to 0.1, 0.15, 0.2, 0.25, 0.3, 0.35, 0.4, 0.45, 0.5, 0.6, 0.8, 1, 1.2, 1.5 or 2 and ranges therebetween. Alternatively or additionally, a molar ratio of the repeat units according to Formula (1A) relative to the repeat units according to Formula (1B) is in a range of 0.05 to 0.2, for example at least and/or up 0.05, 0.07, 0.1, 0.12, 0.15, 0.17, or 0.2 and ranges therebetween. The foregoing amounts, ratios, and ranges can represent a combined amount of all repeat units of Formula (1A) or Formula (1B) in the ethylenic polymer, for example when the ethylenic polymer include multiple different types of the repeat units.

In the second repeat units of Formula (2), the R^{2′} group can be represented by —C(═O)O—R², in which the carbonyl group (C(═O)) carbon atom of the ester group (—OC(═O)—) is bonded to the carbon atom of the ethylenic backbone, and the oxygen atom (O) is bonded to the pendant R² group. The R² group can be a hydrocarbon group containing 1 to 40 or 1 to 18 carbon atoms, for example at least and/or up to 1, 2, 3, 4, 5, 6, 7, 8, 9, 10, 12, 14, 16, 18, 20, 25, 30, 35, or 40 carbon atoms and ranges therebetween. The hydrocarbon groups can include linear, branched, or cyclic, substituted or unsubstituted alkyl or alkenyl (e.g., having one or more C═C unsaturated bonds) groups, for example with or without N, O, and/or S heteroatoms or heteroatom-containing groups as substituents. In embodiments, the hydrocarbon group is an unsubstituted alkyl group. In embodiments, the second repeat units of Formula (2) can represent polymerized residues of alkyl (meth)acrylates, for example where R^{A} and R^{B} are H atoms, R^{C} is an H atom (acrylate) or a CH₃ group (methacrylate), and R² is an alkyl group. Representative alkyl (meth)acrylates can include butyl methacrylate (i.e., R² is a C4 alkyl group), methyl methacrylate (i.e., R² is a C1 alkyl group), lauryl methacrylate (i.e., R² is a C12 alkyl group), stearyl methacrylate (i.e., R² is a C18 alkyl group), etc. When present, the particular size or length of the R² group (e.g., relatively shorter or longer alkyl group) and the R^{C} group (e.g., hydrogen or methyl) can be selected to adjust or control the glass transition temperature (Tg) of the ethylenic polymer, which can generally range from −100° C. to 70° C. or −20° C. to 35° C.

In embodiments, the second repeat units can be present in an amount in a range of 5 wt. % to 50 wt. % or 5 wt. % to 20 wt. % relative to the ethylenic polymer, for example at least and/or up to 5, 10, 15, 20, 25, 30, 35, 40, 45, or 50 wt. % and ranges therebetween. Alternatively or additionally, the second repeat units can be present in an amount in a range of 3 mol. % to 50 mol. % or 3 mol. % to 15 mol. % relative to the ethylenic polymer, for example at least and/or up to 3, 5, 10, 15, 20, 25, 30, 35, 40, 45, or 50 mol. % and ranges therebetween. The foregoing amounts and ranges can represent a combined amount of all second repeat units in the ethylenic polymer, for example when the ethylenic polymer includes multiple different types of second repeat units.

In the third repeat units of Formula (3), the R^{3′} group can be represented by —C(═O)O—R³ or —C(═O)NH₂, in which the carbonyl group (C(═O)) carbon atom is bonded to the carbon atom of the ethylenic backbone as well as to a pendant hydroxyl group (OH), pendant amino group (NH₂), or a pendant ester group (OR³). The R³ group can be a hydrocarbon group containing 1 to 40 or 1 to 6 carbon atoms and at least one carboxylic group (e.g., 1, 2, 3, or more carboxylic groups), for example at least and/or up to 1, 2, 3, 4, 5, 6, 7, 8, 9, 10, 12, 14, 16, 18, 20, 25, 30, 35, or 40 carbon atoms and ranges therebetween. The hydrocarbon groups can include linear, branched, or cyclic, alkyl or alkenyl (e.g., having one or more C═C unsaturated bonds) groups that are substituted with or otherwise contain at least one carboxylic group, for example with or without additional N, O, and/or S heteroatoms or heteroatom-containing groups as substituents (e.g., in other ester or ether groups). In embodiments, the hydrocarbon group is a monocarboxylic alkyl group. In embodiments, the third repeat units of Formula (3) can represent polymerized residues of (meth)acrylic acid or carboxylated (meth)acrylates, for example where R^{A} and R^{B} are H atoms, R^{C} is an H atom (acrylate) or a CH₃ group (methacrylate), and R³ is an alkyl group with a pendant or terminal carboxylic group. Representative carboxylated (meth)acrylates can include 2-carboxyethyl acrylate (i.e., R³ is a C3 alkyl carboxylic group —C₂H₅C(═O)OH), 2-carboxyethyl methacrylate, 2-carboxyethyl (meth)acrylate oligomers, etc. The pendant carboxylic groups or amino groups in the third repeat units promote recyclability and emulsion stability. As formed and during typical use in an emulsion, the pH is generally low enough (e.g., about pH 5) such that the carboxylic group of the third repeat units typically remains substantially in acid (or non-ionized) form (e.g., —C(═O)OH vs. —C(═O)O⁻), for example as applied to a substrate in a coating process and/or in a dried coating on the substrate.

In embodiments, the third repeat units can be present in an amount in a range of 0.1 wt. % to 10 wt. %, 0.1 wt. % to 5 wt. %, or 0.2 wt. % to 4 wt. % relative to the ethylenic polymer, for example at least and/or up to 0.1, 0.2, 0.3, 0.5, 0.7, 1, 1.2, 1.5, 2, 2.5, 3, 4, 5, 6, 7, 8, 9, or 10 wt. % and ranges therebetween. Alternatively or additionally, the third repeat units can be present in an amount in a range of 0.5 mol. % to 8 mol. % relative to the ethylenic polymer, for example at least and/or up to 0.5, 1, 1.5, 2, 3, 4, 5, 6, or 8 mol. % and ranges therebetween. The foregoing amounts and ranges can represent a combined amount of all third repeat units in the ethylenic polymer, for example when the ethylenic polymer includes multiple different types of third repeat units.

In the fourth repeat units of Formula (4), the R⁴ group can be a hydrocarbon group containing 6 to 40 or 6 to 12 carbon atoms and at least one aromatic group (e.g., 1, 2, 3, or more aromatic groups), for example at least and/or up to 6, 7, 8, 9, 10, 12, 14, 16, 18, 20, 25, 30, 35, or 40 carbon atoms and ranges therebetween. The hydrocarbon groups can include monoaromatic groups (e.g., phenyl group) or polyaromatic groups (e.g., bi- or polyphenyl groups, fused polynuclear groups such as naphthyl groups), which can be substituted with linear, branched, or cyclic, substituted or unsubstituted alkyl or alkenyl (e.g., having one or more C═C unsaturated bonds) groups, for example with or without N, O, and/or S heteroatoms or heteroatom-containing groups as substituents. In embodiments, the hydrocarbon group is an unsubstituted aromatic group. In embodiments, the third repeat units of Formula (3) can represent polymerized residues of vinyl aromatics, for example where R^{A}, R^{B}, and R^{C} are H atoms, and R⁴ is an aromatic group. Representative vinyl aromatics can include styrene (i.e., R⁴ is a C6 aromatic or phenyl group). The fourth repeat unit, when present, can be used to further control or select properties of the ethylenic polymer, for example by increasing Tg, increasing hydrophobicity, increasing or adjusting mechanical properties and film properties, and reducing tackiness.

In embodiments, the fourth repeat units can be present in an amount in a range of 1 wt. % to 40 wt. % or 5 wt. % to 30 wt. % relative to the ethylenic polymer, for example at least and/or up to 1, 2, 5, 10, 15, 20, 25, 30, 35, or 40 wt. % and ranges therebetween. Alternatively or additionally, the fourth repeat units can be present in an amount in a range of 1 mol. % to 40 mol. % or 5 mol. % to 30 mol. % relative to the ethylenic polymer, for example at least and/or up to 1, 2, 5, 10, 15, 20, 25, 30, 35, or 40 mol. % and ranges therebetween. The foregoing amounts and ranges can represent a combined amount of all fourth repeat units in the ethylenic polymer, for example when the ethylenic polymer includes multiple different types of fourth repeat units.

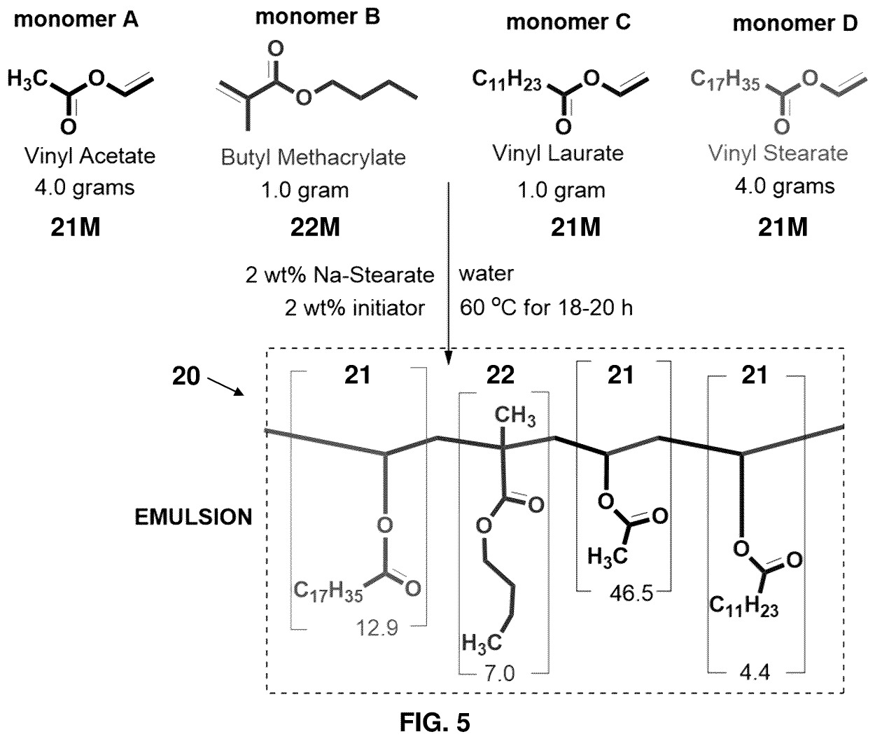

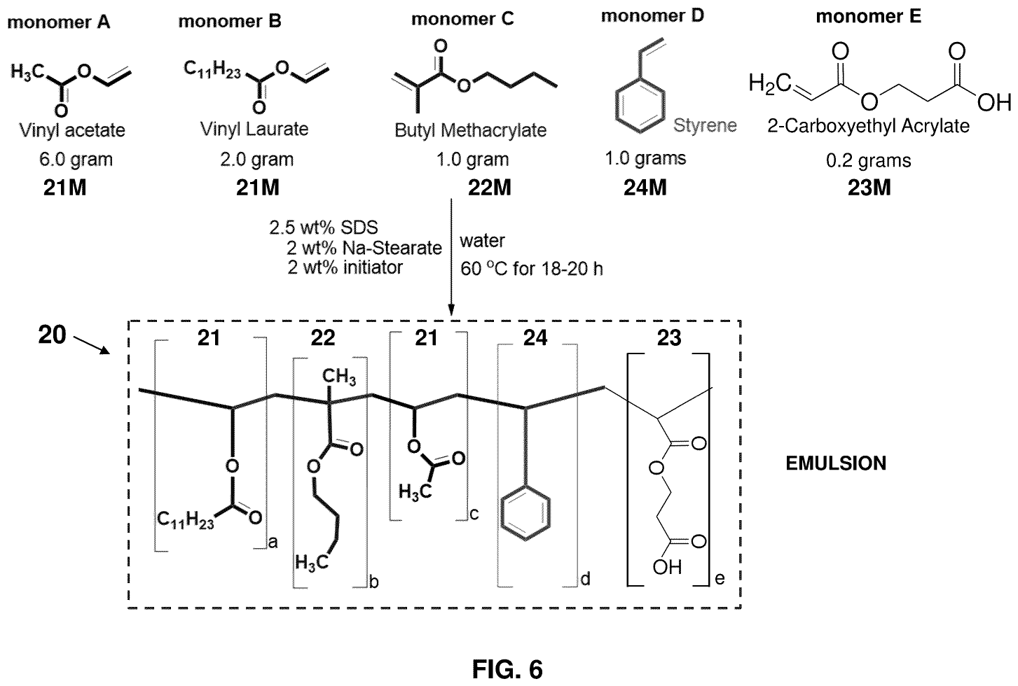

FIG. 5 and FIG. 6 illustrate ethylenic polymers 20 according to the disclosure and as described in more detail below in the examples. In FIG. 5, the ethylenic polymer 20 includes three types of first repeat units 21, including those derived from a first monomer 21M vinyl acetate (monomer A; corresponding to a shorter repeat unit according to Formula (1B)), another first monomer 21M vinyl laurate (monomer C; corresponding to a longer repeat unit according to Formula (1A)), and another first monomer 21M vinyl stearate (monomer D; corresponding to a longer repeat unit according to Formula (1A)). The ethylenic polymer 20 of FIG. 5 also includes second repeat units 22 derived from a second monomer 22M butyl methacrylate (monomer B). In FIG. 6, the ethylenic polymer 20 includes two types of first repeat units 21, including those derived from a first monomer 21M vinyl acetate (monomer A; corresponding to a shorter repeat unit according to Formula (1B)), and another first monomer 21M vinyl laurate (monomer B; corresponding to a longer repeat unit according to Formula (1A)). The ethylenic polymer 20 of FIG. 6 also includes second repeat units 22 derived from a second monomer 22M butyl methacrylate (monomer C), third repeat units 23 derived from a third monomer 23M 2-carboxyethyl acrylate (monomer E), and fourth repeat units 24 derived from a fourth monomer 24M styrene (monomer D).

The ethylenic polymer can have a molecular weight in a range of 1,000-1,000,000 g/mol, for example representing a weight-average molecular weight (Mw) or a number-average molecular weight (Mn). For example, the molecular weight can be at least and/or up to 1000, 2000, 5000, 8000, 10000, 20000, 30000, 50000, 70000, 100000, 150000, 200000, 250000, 300000, 400000, 500000, 600000, 800000, or 1000000 g/mol and ranges therebetween. The foregoing weights can represent an average (e.g., number- or weight-average) molecular weight for an ethylenic polymer containing a distribution of different sizes/molecular weights. Alternatively, the foregoing molecular weight ranges can represent lower and upper bounds, respectively, of a molecular weight distribution for the ethylenic polymer (e.g., 1%/99%, 5%/95%, or 10%/90% cuts of a cumulative distribution).

The ethylenic polymer generally has a random copolymer structure between its different repeat units, for example a statistical/random/blocky copolymer. The ethylenic polymer is generally linear or unbranched and not crosslinked. The ethylenic polymer is primarily amorphous in nature. The ethylenic polymer typically has a glass transition temperature (Tg) below 70° C., for example at least and/or up to −100, −40, −20, −10, −5, 0, 5, 10, 15, 20, 25, 30, 35, 40, 50, 60, or 70° C. and ranges therebetween.

The ethylenic polymer can be formed by an emulsion polymerization method in which the various monomers corresponding to the repeat units of the ethylenic polymer are combined in an aqueous medium and subjected to free radical polymerization for a sufficient time and at a sufficient temperature to polymerize the ethylenic functional groups of the monomers (e.g., vinyl groups, (meth)acrylate groups) and form the ethylenic backbone of the ethylenic polymer. The aqueous medium generally includes 0.05-5 wt. % of a free radical initiator such as a persulfate compound, organic or inorganic peroxide, etc. The aqueous medium suitably also include an emulsifier. Example reaction conditions can include heating at about 40-80° C. or 50-70° C. for about 4-24 hr or 12-20 hr. The ethylenic polymer can be present in the emulsion in the form of nanosized polymer particles, for example having a diameter or other characteristic size of 20-500 nm or 100-300 nm, for example at least and/or up to 20, 50, 70, 100, 120, 150, 200, 250, 300, 400, or 500 nm. The foregoing sizes can represent an average (e.g., number-, volume-, area-, or weight-average) size for an ethylenic polymer containing a distribution of different sizes. Alternatively, the foregoing size ranges can represent lower and upper bounds, respectively, of a size distribution for the ethylenic polymer particles (e.g., 1%/99%, 5%/95%, or 10%/90% cuts of a cumulative distribution).

In embodiments, the monomers corresponding to the repeat units of the ethylenic polymer can first monomers represented by Formula (1M), second monomers represented by Formula (2M), third monomers represented by Formula (3M), and/or fourth monomers represented by Formula (4M):

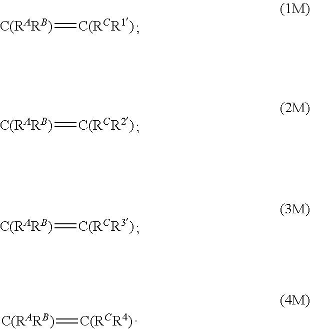

In each or Formulas (1M)-(4M), the groups R^{A}, R^{B}, R^{C}, R^{1′}, R^{2′}, R^{3′}, and R⁴ can have the same options and relative amounts or ranges as described above for the repeat units, for example where monomer amounts or ranges are expressed relative to total monomers (i.e., instead total ethylenic polymer).

The emulsion polymerization method can form as a product an ethylenic polymer emulsion (or dispersion) including the aqueous medium and the ethylenic polymer dispersed in the aqueous medium. In embodiments, water can be present in the aqueous medium in an amount in a range of 50 wt. % to 99 wt. % or 60 wt. % to 90 wt. % relative to the emulsion, for example at least and/or up to 50, 55, 60, 65, 70, 75, 80, 85, 90, 95, 98, or 99 wt. % and ranges therebetween. In embodiments, the ethylenic polymer can be present in the aqueous medium in an amount in a range of 1 wt. % to 50 wt. % or 10 wt. % to 40 wt. % relative to the ethylenic polymer, for example at least and/or up to 1, 2, 5, 10, 15, 20, 25, 30, 35, 40, 45, or 50 wt. % and ranges therebetween. The foregoing amounts and ranges can represent amounts as added to the emulsion polymerization reaction medium and/or as present in the ethylenic polymer emulsion product.

The emulsifier can be present in the aqueous medium in an amount of 0.1 wt. % to 10 wt. % or 0.1 wt. % to 3 wt. % relative to the emulsion, for example at least and/or up to 0.1, 0.2, 0.5, 1, 1.5, 2, 2.5, 3, 5, 7, or 10 wt. % and ranges therebetween. Alternative or additionally, the emulsifier can be present in the aqueous medium in an amount of 1 wt. % to 20 wt. % relative to the ethylenic polymer, for example at least and/or up to 1, 2, 3, 5, 7, 10, 12, 15, or 20 wt. % and ranges therebetween. The emulsifier can be any suitable emulsifier forming an oil-in-water emulsion, such as sodium stearate or sodium dodecyl sulfate. Other examples of suitable emulsifiers include sodium dodecylbenzenesulfonate; polyoxyethylene alkylphenyl ether sulfate (salt); polyoxyethylene alkyl ether sulfate (salt); alkylbenzenesulfonic acids; sulfonated fatty acids; fatty alcohol sulfates; alkylphenol sulfate (ester); alkyl alcohol sulfates; alkoxylated C9-C15 alcohol sulfate (salt); sodium stearate; sodium lauryl sulfate (SLS); sodium dodecyl sulfate (SDS); alkoxylated C8-C16 alcohol; alkylphenol ethoxylates; primary alcohol ethoxylates; fatty acid ethoxylates; alkanolamide ethoxylates; fatty amine ethoxylates; EO/PO block copolymers; alkylpolyglucosides; ethoxylated aliphatic vicinal diols (C8-C25); quaternized amine alkoxylates; cetyltrimethylammonium bromide (CTAB); dodecyltrimethylammonium chloride (DTAC); alkylbetaines; alkylamidobetaines; sulfobetaines, and polyvinyl alcohol (87-99.99% hydrolyzed).

In embodiments, a combined amount of water, ethylenic polymer(s), emulsifier(s), and any remaining initiator is at least 80 wt. % relative to the emulsion, for example at least and/or up to 80, 85, 90, 95, 98, 99, 99.9, or 100 wt. % and ranges therebetween. Alternatively or additionally, the emulsion can be substantially free from components other than water, ethylenic polymer(s), emulsifier(s), and initiator(s), for example containing not more than 0.01, 0.1, 0.2, 0.5, 1, 2, 5, 10 wt. % of such other components.

### Coated Article

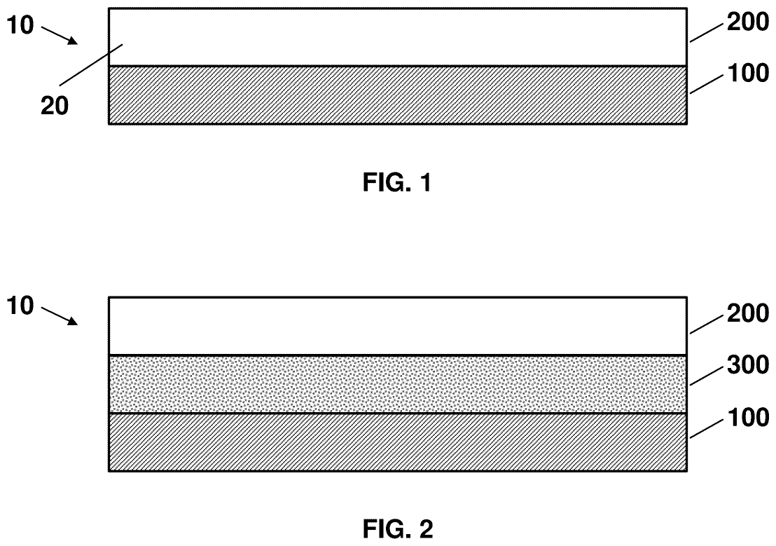

As illustrated in FIGS. 1-4, the disclosure provides a coated article 10 including a substrate 100, a coating or layer 200 on or adjacent to the substrate 100, optionally an additional coating or layer 300 on or adjacent to the substrate 100 or coating 200. The coating 200 can include the ethylenic polymer according to any of the variously disclosed embodiments. The coating can be applied by any suitable method, for example from a solvent solution or an aqueous dispersion or emulsion of the ethylenic polymer (e.g., solvent casting). In other embodiments, the coating can be applied in the form of a melt coating of the ethylenic polymer (e.g., extrusion and non-extrusion melt-coating). The substrate 100 is suitably a cellulosic substrate such as a paper substrate. The ethylenic polymer can be used as a coating directly on a cellulosic substrate, or as a top layer on an already-coated cellulosic substrate (e.g., with a first coating on the substrate such as a polymer like starch, and then a top or second coating of the ethylenic polymer). The ethylenic polymer can also be applied as a coating on other materials such as plastic films/bottles; water repellent fabrics; automotive polishes, as mold release agents in mold making, and other non-packaging applications. Typical coating 200 thicknesses can be 1 μm to 1000 μm or 20 μm to 50 μm. For example, the coating 320 can have thickness of at least 1, 2, 5, 10, 20, 30, 50, 100, 200, or 300 μm and/or up to 30, 50, 70, 100, 200, 500, 700, or 1000 μm. Typical cast coatings can have thicknesses of 10 μm to 100 μm. As described herein, multiple coating layers can be applied to substrate 100 to form even thicker layers of the coating 320 (e.g., above 1000 μm, 2000 μm, or otherwise) if desired.

The coated article 10 of the disclosure includes a substrate 100. Examples of suitable substrates include, but are not limited to, porous substrates and other substrates. In the case of a coating on paper or other porous substrate, a layer or layers including nitrogen-containing polymers such as polyethylene imine (PEI), poly(diallyldimethylammonium chloride) (polyDADMAC), polyacrylic acid (PAA), PEI-PAA, chitosan, starch, cationic starch, polyvinyl alcohol (PVOH) with or without calcium acetate, starch with calcium acetate, and/or blends thereof can be applied on the substrate as a first or base layer (e.g., as a surface sizing) to reduce the occurrence of stickies, and then coated with the ethylenic polymer as a second layer (e.g., with the first layer positioned between and/or adhered to the substrate and the second layer). When the substrate 100 is a porous substrate, the coating 200 and/or the first layer thereof, as described herein, can at least partially fill the pores of the substrate. The coated articles generally can use any porous substrate, cellulosic or non-cellulosic, for example porous metal substrates, porous plastic (e.g., polymeric foam) substrates, and porous cellulosic substrates. A cellulosic substrate generally includes at least one of cellulose and hemicellulose, and it can further include lignin (e.g., as a lignocellulosic substrate).

In general, when the substrate is a cellulosic substrate, the cellulosic substrate is not particularly limited, and can be formed from any cellulosic material desired for protection with an ethylenic polymer coating. For example, the substrate can be a molded fiber containers, paper, paperboard, wood, or fabric (or textile). Examples of paper substrates can include, but are not limited to, generally thinner, flexible papers, for example useful as wrapping materials, as well as generally thicker, rigid papers or cardboard (e.g., corrugated paper cardboard, paperboards), for example useful as box, container, plate, cup, or other storage or food-service items. Suitable wood materials can be any type of wood commonly used in home, office, and outdoor settings. Suitable fabric or textile materials can include any cellulosic materials commonly used in garments or otherwise, such as cotton, jute, flax, hemp, etc. In some embodiments, cationic starches, PEI, and other polymeric or inorganic basic ingredients can be used either as a blend with ethylenic polymers or as a separate base layer in paper coatings. These components help to complex with the carboxylic acid (COOH) groups of the ethylenic polymers, facilitating their solubilization and thus enabling the recycling of coated paper. In some embodiments, the cationic starches, PEI, and other polymeric or inorganic basic ingredients can be added during recycling (e.g., in an amount of about 0.1-5 wt. % relative to coated paper being recycled), which will facilitate repulping, recycling, and contamination removal during recycling.

In embodiments, the porous substrate includes a porous cellulosic substrate. In embodiments, the cellulosic substrate includes paper, corrugated board, cardboard, wood, fabric, and any combination thereof. The cellulosic substrate can be selected from the group of paper (bleached, unbleached, coated (pores still remain) and uncoated, supercallendered), corrugated board, cardboard, wood, and fabric (or textile). In some embodiments, the cellulosic substrate is in the form of a packaging box (e.g., corrugated boxes, cardboard boxes, cartons).

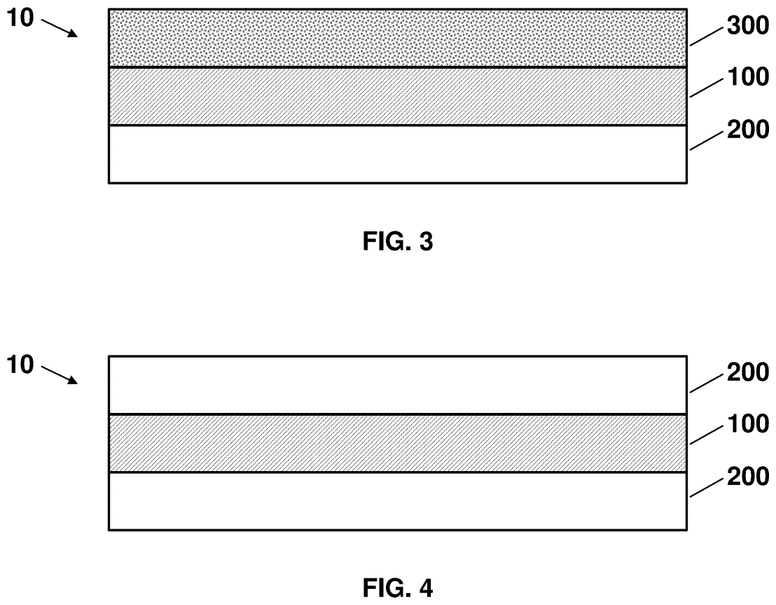

In embodiments, the substrate 100 has opposing first and second surfaces, and both surfaces of the substrate 100 are coated with an ethylenic polymer coating 200 as described herein (FIG. 4). The coatings 200 on opposing surfaces can be the same as or different from each other. In embodiments, the article 10 can include the additional layer 300 in between the substrate 100 and the coating 200 (FIG. 2), or the article 10 can include the additional layer 300 on an opposing surface of the substrate 100 relative to the coating 200 (FIG. 3). The additional layer 300 can be a barrier layer such as a gas barrier layer or an oil-resistant layer. For example, the additional layer 300 can be chosen from a metallized layer, a vinyl alcohol-bearing polymer such as plasticized or unplasticized, modified or unmodified PVOH or EVOH, a G-polymer (vinyl alcohol copolymer) or oil-resistant hydrophilic polymers such as starch, chitosan, etc. The layer 300 can include a metal acetate such as Group I, II, or Ill metal acetate (e.g., sodium, calcium, or aluminum acetate) in the range of 0.1-10 wt. % or 1-5 wt. % with respect to the coating content of the top layer or base layer. The metal acetate can further improve and overcome any stickies. For example, calcium acetate can be added to starch and applied as sizing/coating onto paper before applying the emulsion top layer. By this, the acetate does not come into direct contact with the food/liquid during use but functions as a stickies mitigator during the recycling step by complexing with the carboxylic groups of the polymer. Layer 300 can have fillers such as graphene oxide, nano clay, and/or cellulose nanocrystals, cellulose nano/microfibrils (CNF/CMF), and inorganic fillers such as CaCO3 and NaCO3 in the range of 0.1-20 wt %. Optionally, layer 300 also can have polyethylene imine or sodium bicarbonate in amount 0.1-20 wt. %.

The coating 200 and/or additional layer 300 can further include an additive (e.g., a filler). Examples of suitable additives include, but are not limited to, nanoclays, graphene oxide, graphene, silicon dioxide (silica), aluminum oxide, cellulose nanocrystals, carbon nanotubes, titanium dioxide (titania), diatomaceous earth, biocides, pigments, dyes, and thermoplastics. The additives can be included in any one layer or all layers of the ethylenic polymer coating as applied to the (porous and/or cellulosic) substrate. For example, the additives can be included in a solution or mixture containing the ethylenic polymer before it is applied to the substrate. Advantageously, the additives (e.g., fillers) can aid in sealing the substrate pores. Also, fillers can bring color to the substrate (e.g., paper), for example using titanium dioxide filler particles as a whitening agent. Biocidal properties can also be incorporated via nanofiber fillers. Other functions of the fillers (such as antioxidants, vitamin E, anti-fungals) include increasing the shelf-life and nutritional value of the product inside the coated paper. In addition, the first and/or second layers can be loaded with active components that kill certain microorganisms (e.g., bacteria, fungi or other microorganism) such as cimmaldehyde, carvacrol, sorbic acid, and nisin. Furthermore, cellulose nanocrystals, graphene, nanoclay, etc. as fillers can increase the gas and water vapor barrier properties. In embodiments, the coating includes one or more additives selected from the group consisting of nanoclay, graphene oxide, graphene, silicon dioxide (silica), aluminum oxide, cellulose nanocrystals, carbon nanotubes, titanium dioxide (titania), diatomaceous earth, biocides, pigments, dyes, thermoplastics, and combinations thereof. The various fillers and additives can be present in any suitable amount, for example at least 0.001, 0.01, 0.1, 0.2, 0.3, 0.5, 1, 2, 3, or 5 wt. % and/or up to 0.1, 0.2, 0.3, 0.5, 1, 2, 3, 5, 10, 15, or 20 wt. % relative to the coating. The foregoing amounts and ranges can independently apply to all fillers and additives collectively or to individual fillers or additives.

In embodiments, the coated article 10 can have a kit rating in a range of 4 to 12 or 1 to 12. For example, the kit rating can be at least and/or up to 1, 2, 3, 4, 5, 6, 7, 8, 9, 10, 11, or 12. Suitable methods for determining the kit rating include TAPPI methods T599 pm-96 and UM 557.

In embodiments, the coated article 10 can have a cobb (e.g., cobb600 or cobb1800) rating of 80 g/m² or less. For example, the cobb600 or cobb1800 rating can be at least and/or up to 0.1, 0.2, 0.5, 1, 2, 3, 6, 8, 10, 12, 15, 20, 25, 30, 40, 50, 60, 70, or 80 g/m² and ranges therebetween. A suitable method for determining the cobb ratings includes TAPPI method T441 om-09.

In embodiments, the coated article 10 can have a moisture permeability (e.g., water vapor transmission rate; WVTR) between 0.0001-40 g·mm/m²·24 h at 37° C. and 90% RH, for example at least and/or up to 0.0001, 0.001, 0.01, 0.1, 0.2, 0.5, 1, 2, 5, 10, 20, 30, 40, 60, 80, or 100 g·mm/m²·24 h and ranges therebetween at 37° C. and 90% RH. In embodiments, the coated article 10 can have an oxygen permeability (e.g., oxygen transmission rate; OTR) between 0.0001-200 cc·mm/m²·24 h at 23° C. and 50% RH or at 37° C. and 90% RH, for example at least and/or up to 0.0001, 0.001, 0.01, 0.1, 0.2, 0.5, 1, 2, 5, 10, 20, 50, 100, or 200 cc·mm/m²·24 h and ranges therebetween.

In embodiments, the coated article 10 can have a relative permeability for water vapor of 0.5 or less, relative to a corresponding (porous) substrate without the coating thereon. For example, the coated article can have a relative permeability for water vapor of at least 0.00001, 0.0001, 0.001, 0.01, 0.1, 0.2, or 0.3 and/or up to 0.3, 0.4, or 0.5, such as 0.00001, 0.00005, 0.0001, 0.0005, 0.001, 0.005, 0.01, 0.05, 0.1, 0.2, 0.3, 0.4, or 0.5, relative to a corresponding (porous) substrate without the coating thereon (e.g., determined as a ratio of two water vapor transmission rate (WVTR) values). That is, the coated article can have a relative permeability for water vapor of 0.5 or less based on absolute water vapor transmission rates for the coated article and uncoated (porous) substrate. Alternatively or additionally, the coated article can have a relative permeability for non-water gas of at least 0.00001, 0.0001, 0.001, 0.01, 0.1, 0.2, or 0.3 and/or up to 0.3, 0.4, or 0.5, such as 0.00001, 0.00005, 0.0001, 0.0005, 0.001, 0.005, 0.01, 0.05, 0.1, 0.2, 0.3, 0.4, or 0.5, relative to a corresponding (porous) substrate without the coating thereon. This relative permeability for non-water gas can be applicable for one or more gases such as oxygen, nitrogen, carbon dioxide, and other common components of air. Alternatively or additionally, the coated article 10 can have an absolute permeability for water vapor of up to 100 g/m²/day, for example at least 0.1, 1, 2, 5, 7, 10, or 15 g/m²/day and/or up to 10, 15, 20, 25, 30, 40, 50, 60, 80, or 100 g/m²/day.

The water- and oil-resistance properties of the coated article 10 or corresponding coating 200 can be characterized in terms of one or more contact angles for water and/or oil droplets (e.g., vegetable oil such as castor oil) on the coating 200.

In embodiments, the article or coating has a water contact angle in a range from 80° or 90° to 120°, for example at least 80°, 85°, 90°, 95°, 100°, or 105° and/or up to 110°, 115°, or 120°, such as 90°, 95°, 100°, 105°, 110°, 115°, or 120°. The water contact angle can apply, for example, to a measurement after an interval of 30 sec or 5 min after application of a test droplet on the coating surface. In some cases, the water contact angle can be up to about 125° for non-smooth or rough surfaces.

In embodiments, the article or coating is resistant to the spreading of oil on its surface. In embodiments, the article or coating has an oil contact angle in a range from 1° to 65° or 10° to 75°, for example at least 1°, 10°, 20°, 30°, 40°, or 50° and/or up to 40°, 50°, 60°, 65°, 70°, or 75°. The oil contact angle can apply, for example, to a measurement after an interval of 30 sec or 5 min after application of a test droplet on the coating surface.

The contact angles for the article or coating can be higher when additives or nanofillers (e.g., clay, silica, etc.) are included in the composition as compared to a corresponding composition without any nanofillers. For example, in the case of articles or coatings further including one or more additives nanofillers (e.g., nanoclay, graphene oxide, graphene, silicon dioxide (silica), aluminum oxide, cellulose nanocrystals, carbon nanotubes, titanium dioxide), the contact angles suitably can range from 100° to 150° for water (e.g., at least 100°, 110°, 120°, 130° or 140° and/or up to 150°, 140°, 130°, 120°, or 110°), and from 20° to 120° for oil (e.g., at least 20°, 30°, 40°, 50°, 60°, 70°, and/or up to 80°, 90°, 100°, 110°, or 120°).

### Test Methods

Water Resistance: The water resistance of a coating can be measured as a Cobb1800 value that represents grams of water per square meter that a coating or coated article absorbs in 1800 seconds when brought in contact with water. Cobb 1800 values were determined via a TAPPI standard T441 om-09 protocol, where a Cobb sizing tester (Büchel BV Inc. Utrecht, Netherlands) was used to allow DI water (100 mL) to come into contact with a 100-cm² or 133-cm² specimen for 1800 seconds (30 minutes). The paper samples were submerged in 100 mL of deionized water (DI) for 1800 seconds and then water was quickly discharged from each sample, with paper towel being used to absorb excess water. The weight of the water absorbed by the wax was calculated by the difference in the weight of each specimen before and after the test. Cobb 600 and Cobb 60 values can be analogously determined using 600- and 60-second water contact times, respectively. Cobb values are expressed herein in grams per square meter (g/m²) unless otherwise indicated.

Oil/Grease Resistance (Kit Rating): Oil/grease resistance tests were performed in accordance with the T 559 pm-96 standard method or the TAPPI UM 557 standard method. Oil/grease resistance is represented by a kit rating value, where 12/12 denotes the maximum grease resistance, and 0/12 corresponds to no grease resistance. According to the methods, a series of numbered solutions (1-12) with various surface tensions and viscosities (aggressiveness) were prepared by mixing specific proportions of castor oil, n-heptane, and toluene. Higher numbered solutions are more aggressive with lower surface energies (i.e., solution #1 is the least aggressive oil while #12 is the most aggressive oil). A test specimen was placed on a black bench, and various test solutions were gently allowed to drop onto the surface of the specimen from a height of 1.27 cm and quickly removed with a clean tissue after 15 s. The tested area was examined immediately and a specimen with darkened spots was considered to have failed the test. The tested surface was viewed, and if any dark spots emerged after the test had been performed using the liquid with a certain kit number, it was considered to have failed that particular test. The number of the most aggressive solution that remained on the surface of a specimen without causing any failure was reported as the “kit rating.” A higher kit rating indicates stronger grease resistance.

Nuclear Magnetic Resonance (NMR) Analysis: ¹H-NMR spectra for all samples were recorded using 500 MHz NMR spectrometer (Varian 7600-AS, USA). Samples were prepared by dissolving 5 mg of the corresponding polymer in 0.7 mL of deuterated chloroform (CDCl₃). Chemical shift values for all the spectrums were recorded in ppm.

Differential scanning calorimetry analysis (DSC): Differential scanning calorimetry analysis was carried out to find the melting temperatures (Tm) of synthesized samples using a TA Instruments DSC-Q100 system. The analysis was performed at a heating rate of 10° C./min and the heating range was between 0° C. and 250° C.

Thermogravimetric analysis (TGA): Thermogravimetric analysis of all the samples were recorded using thermogravimetric analyzer (Q 50). Samples (8 mg) were heated at a ramping rate of 10° C. per minute in a standard pan, spanning a temperature range of 10° C. to 600° C. The test was performed at a flow rate of 40 mL/min in a nitrogen environment.

Water vapor transmission rates analysis (WVTR): A PERMATRAN-W system (Model 3/34, Mocon Inc., MN, USA) was used to determine water vapor transmission rates (WVTR) at 23° C. and at 50% RH or at 90% RH and 38° C. Paper samples with dimensions of 2.5×2.5 cm² were fixed in an aluminum mask sheet, and a 0.5 cm² open hole was left in the sample to expose it to water vapor. Water vapor permeation was calculated by multiplying thickness of paper samples with water vapor transmission values.

Gel permeation chromatography (GPC) analysis and molecular weight determination: The molecular weights were determined using a size exclusion chromatography (SEC) system (Waters 717 plus Autosampler, Massachusetts, USA). The SEC system was attached to a refractive index detector (Waters 2414), an isocratic pump (Waters 1515), an autosampler (Waters 717), and a series of HR STYRAGEL HR4, HR3, and HR2 (300 mm×7.8 mm I.D.) columns with a controlled temperature of 35° C. and tetrahydrofuran (THF) was employed as an eluent at a flow rate of 1 mL/min. Approximately 2 mg of the copolymer was dissolved in 20 mL of THF and kept overnight before being filtered using a PTFE-GF (polytetrafluoroethylene-glass fiber) syringe filter (pore size=0.45 μm and diameter=13 mm). The polystyrene standard-SHODEX SM-105 supplied by Waters was used for the calibration (which was performed via three replications).

Repulpability: The standard test entitled “BA voluntary standard for repulping and recycling corrugated fiberboard treated to improve its performance in the Presence of water and water vapor-part I repulpability” was used for this analysis. Coated paper (25 g) was cut into strips of 3.2 cm×10.2 cm strips, then soaked in warm water 1500 mL for 4 h. The temperature was maintained at 52° C. (+/−6° C.). After soaking the paper was repulped using a pre heated Modified Waring Blender maintaining a speed of 15000 rpm for four minutes, it was subsequently washed with 500 mL of water. After washing the fibers were deflaked in a British Disintegrator for five minutes (2000 mL, total volume) at 3000 rpm, maintaining the pH of 7+/−0.5 at 52° C. (+/−6° C.). The pulped material was separated in a flat screen with 0.010-inch slots, to determine the fiber recovery as a percentage of the amount of fiber charged. Net accepts and net rejects were stored in aluminum weighing pans and subsequently dried in a laboratory oven at 105° C. for 12 h. The dried net rejects and net accepts were weighed to calculate the yield of repulping. An 85% repulping yield is required to pass this test.

Recyclability: A lab-scale recyclability test was carried out using the modified “FBA voluntary standard for repulping and recycling corrugated fiberboard treated to improve its performance in the presence of water and water vapor-part ii recyclability” test procedure. During the process, 20% coated paper sample (CPBAT-A-S or CPBAT-B-S, each used separately) and 80% uncoated base paper (Uncoated kraft paper, KP) were mixed and repulped in a lab-scale pulper at pH of 7+/−0.5 at 52° C. (+/−6° C.) for 15 minutes. The pulped suspension was passed through a vibration flat screen with 0.0254 cm slots. Handsheets were subsequently made from screen accepts. These handsheets were tested for various properties following TAPPI standards, including coefficient of friction (slide angle) by the TAPPI T815 protocol, short span compression strength (STFI) by the TAPPI T831 protocol, the water drop penetration test, burst strength (TAPPI T403), water-drop penetration (TAPPI T831), and stickies count tests (TAPPI T277). The results were compared to those obtained with a control sample, which was a 100% base paper (uncoated kraft paper) that had been pulped and screened using identical conditions.

### EXAMPLES

The following examples illustrate the disclosed ethylenic polymers and methods for synthesizing the same, but are not intended to limit the scope of any claims thereto. Equivalents (eq.) are listed as molar equivalents unless indicated otherwise.

### Example 1: Vinyl/Acrylic Ethylenic Copolymer

This example illustrates the synthesis and emulsification of an ethylenic polymer according to the disclosure including (i) vinyl first repeat units and (ii) methacrylic second repeat units. The first repeat units correspond to vinyl stearate, vinyl laurate, and vinyl acetate comonomers, and the second repeat units correspond to a butyl methacrylate monomer. The ethylenic polymer was coated on paper substrates and tested for various properties.

Materials: Vinyl laurate (purity 99%; Sigma-Aldrich); vinyl stearate (purity 95%, stabilized with MEHQ; Tokyo Chemical Industry Co.); vinyl acetate (purity 99%; Sigma-Aldrich); butyl methacrylate (purity 99% with monomethyl ether hydroquinone as inhibitor; Sigma-Aldrich); sodium stearate (Thermoscientific); ammonium persulfate (purity 98%; Sigma-Aldrich); aluminum oxide (basic; Sigma-Aldrich); JONCRYL HBP 4030 (acrylic emulsion, ˜40% solid content; BASF).

A polymerized vinyl emulsion was prepared by using bio-based components such as vinyl stearate, vinyl laurate, and sodium-stearate. Additional comonomers included vinyl acetate and butyl methacrylate. The polymerized emulsion can be biodegradable or moderately biodegradable (e.g., such as with co-polyvinyl acetate). The obtained polymerized emulsion was applied as a coating to kraft paper, improving water resistance. Additionally, the coated paper was successfully repulped and recycled, and no contamination and stickies were found on the recycled paper. Table 2 below shows the component amounts for the monomers forming the corresponding polymer as well as the emulsion components.

TABLE 2
Example 1 Vinyl/Acrylic Ethylenic Copolymer and Emulsion

| | | | | |
|---|---|---|---|---|
| Component | g | wt. % | mol | mol. % |

First Monomer

| | | | | |
|---|---|---|---|---|
| Vinyl stearate | 4.00 | 40.0% | 0.01288 | 18.2% |
| Vinyl laurate | 1.00 | 10.0% | 0.00442 | 6.2% |
| Vinyl acetate | 4.00 | 40.0% | 0.04646 | 65.6% |

Second Monomer

| | | | | |
|---|---|---|---|---|
| Butyl methacrylate | 1.00 | 10.0% | 0.00703 | 9.9% |
| Total Polymer | 10.00 | 100.0% | 0.07080 | 100.0% |

Emulsion

| | | |
|---|---|---|
| Polymer | 10.00 | 14.2% |
| Sodium stearate (emulsifier) | 0.30 | 0.4% |
| Ammonium persulfate (initiator) | 0.25 | 0.4% |
| Water | 60.00 | 85.0% |
| Total Emulsion | 70.55 | 100.0% |

Method: Removal of the polymerization inhibitors from the vinylic group chemicals were carried out by their adsorption on the surface of basic alumina (aluminum oxide). Next, the utilized chemicals (in particular the liquid chemicals and deionized water) were degassed via freeze-pump-thaw (FPT) method or purging with continuous flow of nitrogen gas. The degasses chemicals including vinyl laurate (1.0 gram, 4.42 mmole), vinyl acetate (4.0 gram, 46.46 mmole), vinyl stearate (4.0 gram, 12.88 mmole), butyl methacrylate (1.0 gram, 7.03 mmole) and ammonium persulfate (0.25 gram) as catalyst were charged into two-necked flask (100 mL). 60 mL of deionized water (degassed) was next added to the flask. Sodium stearate (as emulsifier), making up 3% of the total chemicals, was then added to the above reaction mixture. The flask was then closed with a rubber stopper and closely wrapped with TEFLON (polytetrafluoroethylene) tape. The reaction mixture was again purged with nitrogen gas for a few minutes to remove any oxygen content in the system while stirring at room temperature. Next the flask was heated to 70° C. for 9-10 hours. After this time, the temperature of the reaction mixture was decreased to 50° C. and stirred further 12-14 hours. A white emulsion was obtained at the end of reaction. FIG. 5 illustrates the starting monomers (top), emulsion polymerization (middle), and final ethylenic polymer structure (bottom) of Example 1.

Casting: The polymerized emulsion (3.333 g polymer dissolved per 20 ml of water) was casted in a 1 m×1 m square area on a kraft paper substrate. The coated paper was dried at room temperature for 2-3 hours to evaporate the water from the surface. Next the coated paper was kept at 130-140° C. for 10 minutes.

Water Resistance: A Cobb600 analysis was carried out to determine the water resistance of the coated paper. The Cobb600 value was approximately 15 to 20 for the coated sample. It was observed that an uncoated paper control absorbed water in few seconds, while the coated paper of Example 1 retained water droplets on its surface for several hours (i.e., without absorbing water).

Repulpability/Recyclability: Conventional coated paper is typically not recyclable because of the coating materials used. In contrast, the ethylenic polymer according to the disclosure can provide a coating material (e.g., formed from an emulsion of the ethylenic polymer) that degrades when the coated paper ends up in a landfill, but which can still be recycled if the coated paper or boxes are sent to a recycling facility.

To evaluate repulpability and recyclability, the coated paper was blended in a blender to provide pulp. The obtained pulp was repulped (% fibers obtained after passing the screen) using the method described above. The recycled paper or handsheet (pre-dried at room temperature) was inspected for stickies and contamination. To conduct this test, the dried handsheet was placed between the two jaws of a compression mold, heated to 350° F., and pressed at 500 psi for five minutes. There were no stickies or contamination observed from the coated paper of Example 1.

In one another experiment, 10% JONCRYL HBP 4030 (1.0 mL) commercial acrylic emulsion was added to the to the ethylenic polymer emulsion (i.e., 3.333 g polymer per 20 mL of deionized water), and the resulting mixture was used to apply a blend coating (i.e., blend of Example 1 ethylenic polymer and JONCRYL acrylic polymer) on a paper substrate as described above. The addition of the commercial acrylic emulsion also improved the water resistance of the coated paper, and no negative impact on the recyclability was observed.

### Examples 2-13: Vinyl/Acrylic Ethylenic Copolymer

This example illustrates the synthesis and emulsification of a series of ethylenic polymers according to the disclosure including (i) vinyl first repeat units and one or more of (ii) methacrylic second repeat units, (iii) acrylic third repeat units with carboxylic groups, and (iv) vinyl fourth repeat units with aromatic groups. Similar to Example 1, a 100 mL Schlenk flask was charged with monomer components in degassed and deionized water. The liquid chemicals were purified (i.e., removal of inhibitors from the chemicals via passing alumina). The reaction flask was then charged with about 2-4% different additives (e.g., emulsifiers, other monomers such as acrylic acid, etc.) followed by the addition of about 2% ammonium per sulfate as initiator. The reaction flask was tightly closed with a rubber septum and TEFLON tape to restrict any air or oxygen movement into the system. The reaction flask was again degassed (deoxygenated) with nitrogen purging for 20-25 minutes. Next the nitrogen line was removed and the Schlenk flask was exposed to heat (60° C.) for 15-20 hours. The ethylenic polymers were coated on paper substrates and tested for various properties.

Several ethylenic polymers were synthesized to evaluate the effect of different monomer and emulsion components on the resulting ethylenic polymer. The initial emulsions were prepared using 60 g of deionized (DI) water for 10 g of monomers (corresponding to 10 g of synthesized ethylenic polymer), and this ratio was reduced to 20 g of DI water per 10 g of monomers (or ethylenic polymer). Similar variation was carried out for the concentrations of sodium dodecyl sulfate (SDS), sodium stearate, acrylic acid (or its analogs) and ammonium persulfate (radical initiator). The different examples demonstrated that incorporating more than 2 wt. % of acrylic acid (or an analogous acidic comonomer, (relative to the monomer weight) could have a detrimental effect on emulsion stability and coating performance. A goal was to provide a relatively concentrated emulsion having a solid (or ethylenic polymer) content of about 33-35 wt. %. Subsequent syntheses evaluated different emulsion performance characteristics, including emulsion formation and stability (i.e., weight fraction of polymer that remains emulsified or dispersed vs. a solid precipitate), odor, coating quality, tackiness, water resistance, oil resistance, recyclability of the coated materials and the overall reliability of the coated substrates. These properties were further tuned by chemical modifications, adjustments to the method of reagent addition, and other process variables. Table 3 and Table 4 below shows the component amounts for the monomers forming the corresponding polymer as well as the emulsion components, emulsion properties, and coating properties. Example 13 provided the best combination of coating properties, water resistance, oil resistance, and recyclability. FIG. 6 illustrates the starting monomers (top), emulsion polymerization (middle), and final ethylenic polymer structure (bottom) of Example 13. Several other examples provided good combinations of one or more of coating properties, water resistance, oil resistance, and recyclability.

TABLE 3
Examples 2-13 Vinyl/Acrylic Ethylenic Copolymers and Emulsions (wt. %)

| | | | | | | | | | | | | |
|---|---|---|---|---|---|---|---|---|---|---|---|---|
| | Ex. | Ex. | Ex. | Ex. | Ex. | Ex. | Ex. | Ex. | Ex. | Ex. | Ex. | Ex. |
| | 2 | 3 | 4 | 5 | 6 | 7 | 8 | 9 | 10 | 11 | 12 | 13 |
| Component | wt % | wt % | wt % | wt % | wt % | wt % | wt % | wt % | wt % | wt % | wt % | wt % |

First Monomer

| | | | | | | | | | | | | |
|---|---|---|---|---|---|---|---|---|---|---|---|---|
| Vinyl stearate | | | | | | | 30.0 | 9.9 | | | 9.8 | |
| Vinyl laurate | 19.6 | 19.6 | 19.8 | 19.8 | 19.8 | 19.6 | | 19.8 | 19.6 | 14.7 | 19.6 | 19.6 |
| Vinyl acetate | 58.8 | 49.0 | 59.4 | 49.5 | 59.4 | 49.0 | 30.0 | 49.5 | 49.0 | 49.0 | 49.0 | 58.8 |
| Vinyl propanoate | | | | 9.9 | | 9.8 | | | 9.8 | 9.8 | | |
| Acrylonitrile | | | | | 19.8 | | | | | | | |

Second Monomer

| | | | | | | | | |
|---|---|---|---|---|---|---|---|---|
| Butyl methacrylate | 9.8 | | | 20.0 | | | | 9.8 |
| Stearyl methacrylate | | 29.4 | 9.9 | | | | | |
| Methyl methacrylate | | | | | 9.9 | | 9.8% | |
| Lauryl methacrylate | | | | | | 14.7% | | |

Third Monomer

| | | | | | | | | | | | |
|---|---|---|---|---|---|---|---|---|---|---|---|
| Acrylic acid | 2.0 | 2.0 | 1.0 | 1.0 | 1.0 | 2.0 | 1.0 | | | 1.0 | |
| 2-Carboxyethyl acrylate | | | | | | | | 2.0 | 2.0 | 1.0 | 2.0 |

Fourth Monomer

| | | | | | | | | | | | | |
|---|---|---|---|---|---|---|---|---|---|---|---|---|
| Styrene | 9.8 | | 9.9 | 19.8 | | 19.6 | 20.0 | 9.9 | 19.6 | 9.8 | 9.8 | 9.8 |
| Total Polymer | 100 | 100 | 100 | 100 | 100 | 100 | 100 | 100 | 100 | 100 | 100 | 100 |

Emulsion

| | | | | | | | | | | | | |
|---|---|---|---|---|---|---|---|---|---|---|---|---|
| Polymer | 33.3 | 32.9 | 32.8 | 32.8 | 32.8 | 33.1 | 14.1 | 32.8 | 33.1 | 33.1 | 33.1 | 33.1 |
| Sodium stearate (emulsifier) | | 1.3 | 0.7 | 0.7 | 0.7 | 0.6 | 0.4 | 0.7 | 0.6 | 0.6 | 0.6 | 0.6 |
| Sodium dodecyl sulfate | 0.8 | 0.8 | 0.8 | 0.8 | 0.8 | 0.8 | 0.4 | 0.8 | 0.8 | 0.8 | 0.8 | 0.8 |
| (emulsifier) | | | | | | | | | | | | |
| Ammonium persulfate | 0.7 | 0.6 | 0.7 | 0.7 | 0.7 | 0.6 | 0.3 | 0.7 | 0.6 | 0.6 | 0.6 | 0.6 |
| (initiator) | | | | | | | | | | | | |
| Water | 65.3 | 64.4 | 65.0 | 65.0 | 65.0 | 64.8 | 84.8 | 65.0 | 64.8 | 64.8 | 64.8 | 64.8 |
| Total Emulsion | 100 | 100 | 100 | 100 | 100 | 100 | 100 | 100 | 100 | 100 | 100 | 100 |

Emulsion Properties

| | | | | | | | | | | | | |
|---|---|---|---|---|---|---|---|---|---|---|---|---|
| Emulsion % (balance | 80 | 100 | 100 | 100 | 60-70 | 100 | 90-95 | 95-98 | 100 | 100 | 100 | 100 |
| precipitate) | | | | | | | | | | | | |
| Coatings | good | good | good | good | bad | good | good | good | bad | good | good | good |
| Monomer odor | yes | yes | no | no | yes | no | no | no | yes | no | no | no |
| Tackiness | yes | yes | no | no | yes | yes | no | no | no | no | no | no |
| Water resistance (cobb-600) | 9 | 17 | n/a | n/a | n/a | n/a | n/a | n/a | n/a | n/a | 14.3 | n/a |
| Water resistance (cobb-1800) | n/a | n/a | 13, 7.9 | 8.1 | n/a | 73 | 30-35 | 18 | 55 | 21 | n/a | 40, 15 |
| Oil resistance (kit rating) | n/a | n/a | 12 | 12 | n/a | 5-6 | 6 | n/a | n/a | n/a | 12 | 12 |
| Recyclability | n/a | n/a | n/a | no | n/a | yes | yes | yes | yes | no | no | yes |

TABLE 4
Examples 2-13 Vinyl/Acrylic Ethylenic Copolymers (mol. %)

| | | | | | | | | | | | | |
|---|---|---|---|---|---|---|---|---|---|---|---|---|
| | Ex. | Ex. | Ex. | Ex. | Ex. | Ex. | Ex. | Ex. | Ex. | Ex. | Ex. | Ex. |
| | 2 | 3 | 4 | 5 | 6 | 7 | 8 | 9 | 10 | 11 | 12 | 13 |
| | mol | mol | mol | mol | mol | mol | mol | mol | mol | mol | mol | mol |
| Component | % | % | % | % | % | % | % | % | % | % | % | % |

First Monomer

| | | | | | | | | | | | | |
|---|---|---|---|---|---|---|---|---|---|---|---|---|
| Vinyl stearate | | | | | | | 12.4 | 3.5 | | | 3.5 | |
| Vinyl laurate | 9.0 | 11.2 | 9.6 | 9.1 | 7.5 | 8.9 | | 9.7 | 9.1 | 7.2 | 9.6 | 9.2 |
| Vinyl acetate | 71.2 | 73.9 | 75.4 | 59.6 | 59.3 | 58.7 | 44.8 | 63.7 | 59.6 | 63.4 | 63.3 | 72.2 |
| Vinyl propanoate | | | | 10.2 | | 10.1 | | | 10.2 | 10.9 | | |
| Acrylonitrile | | | | | 32.0 | | | | | | | |

Second Monomer

| | | | | | | | | |
|---|---|---|---|---|---|---|---|---|
| Butyl methacrylate | 7.2 | | | 18.1 | | | | 7.3 |
| Stearyl methacrylate | | 11.3 | 3.2 | | | | | |
| Methyl methacrylate | | | | | 11.0 | | 10.9 | |
| Lauryl methacrylate | | | | | | 6.4 | | |

Third Monomer

| | | | | | | | | | | | |
|---|---|---|---|---|---|---|---|---|---|---|---|
| Acrylic acid | 2.8 | 3.5 | 1.5 | 1.4 | 1.2 | 2.8 | 1.5 | | | 1.5 | |
| 2-Carboxyethyl | | | | | | | | 1.4 | 1.5 | 0.8 | 1.4 |
| acrylate | | | | | | | | | | | |

Fourth Monomer

| | | | | | | | | | | | | |
|---|---|---|---|---|---|---|---|---|---|---|---|---|
| Styrene | 9.8 | | 10.4 | 19.7 | | 19.4 | 24.7 | 10.5 | 19.7 | 10.5 | 10.5 | 9.9 |
| Total Polymer | 100 | 100 | 100 | 100 | 100 | 100 | 100 | 100 | 100 | 100 | 100 | 100 |

The ethylenic polymer of Example 13 was evaluated to determine several chemical and thermal properties.

Proton NMR: Proton NMR of Example 13 and its emulsion were performed and compared with NMR spectra of its monomers (vinyl acetate, vinyl laurate, butyl methacrylate, and styrene). The proton NMR spectrum of the ethylenic polymer indicates that all monomers are polymerized and there were no monomers in the emulsion when the CDCl3 was used as solvent. The proton NMR spectrum of the ethylenic polymer emulsion indicates that all monomers are polymerized and there were no monomers in the emulsion when the DMSO4-d6 was used as solvent

Stable Waterborne Emulsions: The waterborne emulsion demonstrated long-term colloidal stability, remaining free of sedimentation, phase separation or creamy layer formation for over 60 days under ambient storage conditions. This level of high emulsion stability is useful for storage, handling, and consistent performance in coating applications.

Water Resistance: The water resistance of the coated paper was evaluated using a Cobb tester. Circular coated samples with a diameter of 13 cm were exposed to 100 mL of deionized water for the duration of 600 seconds (10 minutes). The amount of water absorbed was determined gravimetrically. The coated paper absorbed between 10 to 15 g/m², meaning that 10-15 grams of water were absorbed per square meter of coated surface. In comparison, the uncoated paper showed significantly higher absorption, with values ranging from 80 to 90 g/m² in 10 minutes. The tests were conducted in accordance with TAPPI T441 and ISO 535 protocols.

Oil and Grease Resistance: The oil resistance of the coated paper was evaluated using the kit test method. Coated samples were exposed to standardized kit solutions (ranging from 1 to 12, with higher values indicating stronger resistance) to assess their susceptibility to oil penetration. The vinyl alkanoate-coated paper achieved the maximum kit rating of 12, demonstrating excellent resistance against oil absorption and surface staining. In contrast, the uncoated control paper failed at kit levels 1-2, indicating very poor oil barrier performance. These measurements were conducted following TAPPI T559 and ASTM F119 protocols, confirming that the coated paper provides robust oil and grease resistance suitable for demanding food-packaging applications.

Non-Tacky Coating Surface: There is no universally adopted ASTM standard for surface tackiness of paper coatings, however, ASTM D1146 (Blocking Point of Paper Coatings) was used where two coated samples were placed face-to-face under a standard weight and incubated at 50° C. for 24 hours, then evaluated for blocking (fusion or stickiness). Similarly, the tackiness of the coated surface was also evaluated qualitatively by hand touch as well as by using an industry-standard “block test” under laboratory conditions. No surface tackiness was observed under standard temperature and humidity, suggesting that the final dried film possesses sufficient film-forming properties to resist blocking.

Repulpability (>90% Fiber Recovery): Repulpability of the coated paper samples (of different thickness) were evaluated through a bench-scale test modeled after TAPPI T205 and TAPPI UM 213. Coated samples were cut into small strips and dispersed in 2?L of deionized (DI) water using a standard blender (2-minute high-speed agitation), then screened through a 0.15 mm slotted screen. The coated paper achieved over 90% fiber recovery, indicating that the coating materials do not hinder the reprocessing of fibers during the repulping process.

Recyclability (Lab-Scale FBA Protocol): The coated samples were also tested for recyclability using a modified laboratory-scale procedure inspired by TAPPI UM 213 (Repulpability Testing Procedure) and Fiber Box Association (FBA) protocols. In these tests, 20% of coated materials along with 80% virgin paper were dispersed in water, screened, and examined for the ease of fiber recovery and contaminant removal. Results indicate that the material met the functional requirements for recyclability, with minimal residue/contaminates and stickies formation, suggesting compatibility with paper recycling streams.

Coating Load: The coating application rate was precisely controlled and measured via gravimetric methods consistent with TAPPI T410 (Grammage of Paper and Paperboard). The target coating load was about 5 to 10 g/m², and the average coating load for measured samples was about 7 to 10 g/m², which is substantially lower than traditional wax and PE coatings (typically >15 g/m²). This low coating weight achieves functional water and barrier properties without significantly increasing the basis weight of the final paper product. Achieving performance with low coating loads enhances the material's cost-effectiveness and manufacturability.

ASTM Disintegration Test: To evaluate the disintegration of the polyvinyl alkanoate-based emulsion coated paper and the uncoated paper samples, a disintegration test was performed following the ISO 20200 standard, which is recognized for measuring the disintegration of plastic materials under controlled composting conditions. This method also aligns with ASTM D6400 and supports certification under the Biodegradable Products Institute (BPI) Industrial Compostable Scheme. The aim of the disintegration test is to determine whether the material physically breaks down into small fragments without leaving visible residues in the compost. Pre-cut samples were mixed with certified compost and biomass, then placed in a controlled aerobic composting system maintained at specific temperature and humidity for 84 days (12 weeks). According to ISO 20200, a material passes if no more than 10% of its dry weight remains in particles larger than 2 mm.

At the conclusion of the test, the control (kraft paper) showed 93.2% disintegration, while the polyvinyl alkanoate-coated paper achieved 91.7% disintegration. Both samples successfully meet the pass criteria. These results demonstrate that the ethylenic polymer coating technology is compatible with industrial composting environments and supports the broader goals of end-of-life sustainability for paper-based packaging.

Differential Scanning Calorimetry (DSC): The DSC thermograms (not shown) of the ethylenic polymer show the thermal transitions during both heating and cooling cycles. In the second heating scan, a broad glass transition (Tg) around 0° C., is evident around sub-ambient temperatures, which is consistent with the amorphous character of the vinyl alkanoate copolymer segments. The absence of distinct endothermic or exothermic melting/crystallization peaks confirms that the copolymer is largely amorphous. This behavior arises from the random incorporation of vinyl acetate, vinyl laurate, styrene, and butyl methacrylate, which disrupt crystallinity. The cooling cycle further shows no clear crystallization exotherm, supporting the amorphous nature of the polymer. This amorphous character is desirable for coating applications because it provides uniform film formation, flexibility, and good barrier coverage.

Thermogravimetric Analysis (TGA): The TGA curve (not shown) had a two-step degradation pattern. The first major weight-loss event begins at around 300° C. and peaks around 330° C., corresponding to the breakdown of vinyl acetate units and chain scission in the copolymer, probably the elimination of acetic acid like moieties. The second degradation step occurs between 380-420° C., with a peak around 400° C., attributed to the decomposition of the more hydrophobic segments (vinyl laurate, styrene, and butyl methacrylate). At 600° C., less than 10 wt % residue remains, indicating nearly complete volatilization of the organic matrix. The high onset degradation temperature (>300° C.) demonstrates that the copolymer has good thermal stability, making it suitable for paper-coating processes involving drying or curing at elevated temperatures.

Dynamic Light Scattering (DLS) Analysis: Dynamic light scattering analysis (not shown) of the emulsion gave a Z-average hydrodynamic diameter (D_{VH}) of 170.7 nm with a polydispersity index (PDI) of 0.241. This indicates a particle population centered near 170 nm with moderate polydispersity. The intensity- and volume-weighted distributions show a dominant mode at ˜170 nm with a slight high-size shoulder, consistent with a minor fraction of aggregates; overall, the dispersion is reasonably uniform spanning particle sizes ranging from about 100 nm to 300 nm.

### Further Aspects

Further aspects of the disclosure are provided below. While certain properties or features below are described with respect to a specific Formula I, the properties and features can apply to the ethylenic polymers as described more generally herein.

In an aspect, the disclosure relates to relates to polymer emulsions for paper coatings. In particular, the disclosure relates to vinylic emulsions, which include at least 50% as vinyl alkanoates (e.g., vinyl acetate, vinyl laurates, etc.), their use for paper coating, and recycling of such coated papers. The paper coatings have good water repellency. The obtained coated paper is recyclable and can be biodegradable. The polymer emulsions and coated papers provide sustainable alternatives for existing coated paper products such as corrugated boxes, cups, plates, etc.

In an aspect, the disclosure relates to a synthetic polymer according to the following Formula I:

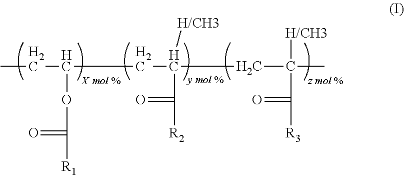

In Formula I: R1 is a hydrocarbon (linear, cyclic, branched, saturated, unsaturated, with or without additional non-Hydrogen and non-Carbon atoms) having 1 to 40 carbon atoms; R2 is a hydrocarbon (linear, cyclic, branched, saturated, unsaturated, with or without additional non-Hydrogen and non-Carbon atoms) having 1 to 40 carbon atoms; and R3 is optionally present (e.g., z can be 0 mol. % or greater than 0 mol. %), can also be —OH, —NH2.

In Formula I, the ratio of x mol %: y mol % is 50:50; 70:30; 90:10; 95:5; and 100:0; The ratio of x mol %:y mol % preferentially is in the range of 80:20 to 95:5 (or 60:40 to 90:10).

The polymer of Formula (I) can be prepared in bulk, in a solvent, and in water in the presence of a suitable free radical initiator such as peroxide, AIBN, etc. initiator are added in the range of 1-10 wt %.

A suitable initiator for waterborne is water soluble initiator such as ammonium persulfate, potassium persulfate, and sodium persulfate. Initiators are added in the range of 1-10 wt. % of the monomer. Monomers to water in the emulsion are in the ratio of 10:90 to 45:55, preferentially about 30:70 (w/w).

In the case of a waterborne reaction, suitable emulsifiers are added.

In the case of bulk/solvent-based systems, the polymer can be used as such or can be emulsified via neutralization of any optional carboxyl groups (—COOH) that are present in Formula I.

Emulsions including the Formula I polymer can be applied on paper (coated/uncoated, bleached, and unbleached).

Emulsions can include the Formula I polymer alone as the single polymeric component, or they can include other materials. The Formula I polymer in these blends can be from 5%-95% (w/w). Some suitable blends include acrylic emulsions, wax emulsions, lignin emulsions, cationic or anionic functional polyester emulsions, and so on.

Inorganic fillers such as calcium carbonate (CaCO3), titania (TiO2), clay, silica, etc., can optionally be used with the Formula I polymer or its blends.

Organic additives such as stearamide can optionally be used with the Formula I polymer or its blends to improve tack resistance.

The Formula I polymer can be used as internal sizing for paper, in which case other additives such as alum and/or other multivalent cations can be included.

The obtained coated paper can have improved water resistance.

The obtained coated paper can have improved oil resistance.

The coated paper can be recyclable.

The coated paper can be biodegradable based on the primarily vinyl alkanoates chemistry which upon hydrolysis creates PVOH-like biodegradable structures.

In an aspect, the disclosure relates to a coated article comprising: a substrate; and a coating on the substrate, the coating comprising the Formula I polymer or its blends.

The substrate can be a cellulosic substrate

The coated article can have a kit rating in a range of 1 to 12; and/or a cobb60 rating of 60 g/m² or less.

The Formula I polymer can be blended with hydrophilic polymers such as vinyl alcohol-bearing polymer such as PVOH (with degree of deacetylation 50-100%, 80-100%, 90-100%), or oil-resistant hydrophilic polymers such as starch (anionic, cationic, native, neutral, esterified, etherified, and so on), chitosan, etc. Hydrophilic polymers (one or more) in the blend are in the range of 1-50%, 5-40%, and 10-30% and so on. Optionally, thickener or thinner are also added to obtain desirable viscosity. The hydrophilic polymers can optionally have one or more plasticizers 0-50 wt %, 5-30 wt %, 10-25 wt %. Common plasticizers include but not limited to water, ethylene glycol, diethylene glycol, polyethylene glycol, propylene glycol, glycerol, etc.

The Formula I polymer can be applied on based coated paper. The base coated paper offers oil resistance.

The coated articles with emulsions or their blends can have WVTR values between 0.0001-100 g·mm/m²·24 h at 37° C. and 90% RH. Preferentially, WVTR is between 0.01-20·mm/m²·24 h.

The coated articles with emulsion (or their blends) can have Cobb60<60 g/m² and kit rating >1.

The coated articles are optionally thermally sealable.

The coating (e.g., Formula I polymer and optionally its blends) can be applied on paper, molded fiber containers, and paper board coated.

The coating (e.g., Formula I polymer and optionally its blends) can be used as internal sizing for molded fiber and pulp.

Paper, molded fiber containers, and paper board coated with the Formula I polymer (or its blends) can be repulpable/recyclable.

Optionally, the Formula I polymer (or its blends) are repulpable/recyclable and can have fillers ranging from 0.1-10 wt % of organic/inorganic materials such as sodium carbonate, sodium bicarbonate, sodium silicate, alums, polyethylene imine prior to applying wax (or wax blends coating).

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. An ethylenic polymer comprising:
first repeat units according to Formula (1) and at least one of second repeat units according to Formula (2), third repeat units according to Formula (3), and fourth repeat units according to Formula (4): 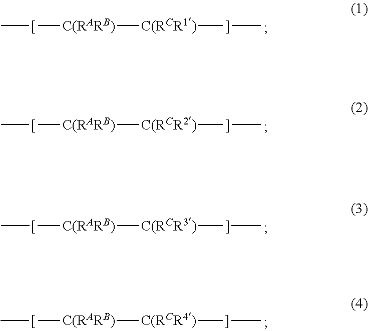
wherein:
R^{A}, R^{B}, and R^{C} are independently selected from the group consisting of H and a hydrocarbon group containing 1 to 6 carbon atoms;
R^{1′} is —OC(═O)—R¹;
R¹ is a hydrocarbon group containing 1 to 40 carbon atoms;
R^{2′} is —C(═O)O—R²;
R² is a hydrocarbon group containing 1 to 40 carbon atoms;
R^{3′} is selected from the group consisting of —C(═O)O—R³ and —C(═O)NH₂;
R³ is H or a hydrocarbon group containing 1 to 40 carbon atoms and having at least one carboxylic group; and
R⁴ is a hydrocarbon group containing 6 to 40 carbon atoms and having at least one aromatic group.

2. The ethylenic polymer of claim 1, wherein:
the first repeat units are present in an amount in a range of 50 wt. % to 95 wt. % relative to the ethylenic polymer.

3. The ethylenic polymer of claim 1, wherein:
the second repeat units are present in the ethylenic polymer in an amount in a range of 5 wt. % to 50 wt. % relative to the ethylenic polymer; and
R² is an alkyl hydrocarbon group containing 1 to 18 carbon atoms.

4. The ethylenic polymer of claim 1, wherein:
the third repeat units are present in the ethylenic polymer in an amount in a range of 0.1 wt. % to 5 wt. % relative to the ethylenic polymer; and
R³ is H or a hydrocarbon group containing 1 to 6 carbon atoms and having at least one carboxylic group.

5. The ethylenic polymer of claim 1, wherein:
the fourth repeat units are present in the ethylenic polymer in an amount in a range of 1 wt. % to 40 wt. % relative to the ethylenic polymer; and
R⁴ is an aromatic hydrocarbon group containing 6 to 12 carbon atoms.

6. The ethylenic polymer of claim 1, wherein:
the first repeat units comprise repeat units according to Formula (1A) and repeat units according to Formula (1B): 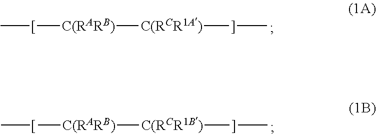
wherein:
R^{1A′} is —OC(═O)—R^{1A};
R^{1A} is a hydrocarbon group containing 9 to 40 carbon atoms (e.g., a relatively heavier vinyl alkanoate such as vinyl laurate or vinyl stearate);
R^{1B′} is —OC(═O)—R^{1B}; and
R^{1A} is a hydrocarbon group containing 1 to 8 carbon atoms (e.g., a relatively heavier vinyl alkanoate such as vinyl acetate or vinyl propanoate).

7. The ethylenic polymer of claim 6, wherein:
a weight ratio of the repeat units according to Formula (1A) relative to the repeat units according to Formula (1B) is in a range of 0.1 to 2.

8. The ethylenic polymer of claim 6, wherein:
the first repeat units are present in an amount in a range of 70 wt. % to 90 wt. % or in a range of 70 mol. % to 90 mol. % relative to the ethylenic polymer;
the repeat units according to Formula (1A) are present in an amount in a range of 10 wt. % to 30 wt. % or in a range of 5 mol. % to 20 mol. % relative to the ethylenic polymer;
the repeat units according to Formula (1B) are present in an amount in a range of 50 wt. % to 70 wt. % or in a range of 60 mol. % to 80 mol. % relative to the ethylenic polymer;
a weight ratio of the repeat units according to Formula (1A) relative to the repeat units according to Formula (1B) is in a range of 0.2 to 0.5;
a molar ratio of the repeat units according to Formula (1A) relative to the repeat units according to Formula (1B) is in a range of 0.05 to 0.2;
the second repeat units are present in the ethylenic polymer in an amount in a range of 5 wt. % to 20 wt. % or 3 mol. % to 15 mol. % relative to the ethylenic polymer;
the third repeat units are present in the ethylenic polymer in an amount in a range of 0.2 wt. % to 4 wt. % or 0.5 mol. % to 8 mol. % relative to the ethylenic polymer; and
the fourth repeat units are present in the ethylenic polymer in an amount in a range of 5 wt. % to 30 wt. % or 5 mol. % to 30 mol. % relative to the ethylenic polymer.

9. The ethylenic polymer of claim 8, wherein:
R^{A}, R^{B}, and R^{C} are H in the repeat units of Formula (1A), Formula (1B), Formula (3), and Formula (4);
R^{A} and R^{B} are H, and R^{C} is CH₃ in the repeat units of Formula (2);
R^{1A} is an alkyl hydrocarbon group containing 10 to 20 carbon atoms;
R^{1B} is an alkyl hydrocarbon group containing 1 to 4 carbon atoms;
R² is an alkyl hydrocarbon group containing 1 to 6 carbon atoms;
R³ is H or a hydrocarbon group containing 1 to 6 carbon atoms and having at least one carboxylic group); and
R⁴ is an aromatic hydrocarbon group containing 6 to 12 carbon atoms.

10. The ethylenic polymer of claim 1, wherein:
the ethylenic polymer has a molecular weight in a range of 1,000 g/mol to 1,000,000 g/mol; and
the ethylenic polymer is a statistical, random, blocky copolymer.

11. A method for forming the ethylenic polymer claim 1, the method comprising:
polymerizing in an aqueous medium first ethylenic monomers corresponding to Formula (1) and at least one of second ethylenic monomers corresponding to Formula (2), third ethylenic monomers corresponding to Formula (3), and fourth ethylenic monomers corresponding to Formula (4), thereby forming the ethylenic polymer.

12. An ethylenic polymer emulsion comprising:
an aqueous medium; and
the ethylenic polymer according to claim 1 dispersed in the aqueous medium.

13. The ethylenic polymer emulsion of claim 12, wherein:
water is present in the aqueous medium in an amount of 50 wt. % to 99 wt. % relative to the emulsion; and
the ethylenic polymer is present in the aqueous medium in an amount of 1 wt. % to 50 wt. % relative to the emulsion.

14. The ethylenic polymer emulsion of claim 12, further comprising:
an emulsifier in an amount of (i) 0.1 wt. % to 10 wt. % relative to the emulsion or (ii) 1 wt. % to 20 wt. % relative to the ethylenic polymer.

15. A coated article comprising:
a substrate; and
a coating on the substrate, the coating comprising the ethylenic polymer according to claim 1.

16. The coated article of claim 15, wherein:
the substrate is a cellulosic substrate.

17. The coated article of claim 15, wherein:
the coating comprises one or more additives blended with the ethylenic polymer.

18. The coated article of claim 17, wherein:
the additives are present in an amount of 0.1 wt. % to 90 wt. % relative to the ethylenic polymer; and
the additives are selected from the group consisting of inorganic fillers, organic additives, polymeric fillers, nanoparticles, natural waxes, ionizable polymers, non-ionizable hydrophilic polymers, and combinations thereof.

19. The coated article of claim 18, wherein the inorganic filler is present and is selected from the group consisting of modified or unmodified titanium dioxide, modified or unmodified silica, modified or unmodified clay, calcium carbonate, aluminum oxide, zinc oxide, talc, mica, barium sulfate, iron oxides, and combinations thereof.

20. The coated article of claim 18, wherein the organic additive is present and is selected from the group consisting of acrylics, polyurethane, epoxy, alkyds, water dispersible ionizable polyesters, water dispersible ionizable synthetic waxes, natural waxes, petroleum waxes, polyhydrocarbons, silicone, vinylic, vinylic-acrylics, polyamide, modified or unmodified carbohydrates, cellulose nanofiber and cellulose nanocrystals, polyvinyl alcohol, polyethylene vinyl alcohols acrylic acid, polyethylene vinyl alcohol, proteins, lignin, polyethers, polyether-polyesters, amine/imine containing polymers, and combinations thereof.

21. The coated article of claim 15, wherein:
the coated article has a kit rating in a range of 4 to 12;
the coated article has a cobb600 rating of 50 g/m² or less (or 60 g/m² or less);
the coated article has a moisture permeability value between 0.0001-40 g·mm/m²·24 h at 37° C. and 90% RH; and
the coated article has an oxygen permeability value between 0.0001-200 cc·mm/m²·24 h at 37° C. and 90% RH.

22. The coated article of claim 15, wherein the coated article is one or more of biodegradable, repulpable, and recyclable.

23. The coated article of claim 15, further comprising a barrier layer.

24. A cellulosic substrate, comprising:
a cellulosic material; and
the ethylenic polymer according to claim 1 distributed throughout the cellulosic material as an internal sizing.
